(19) United States
(12) Patent Application Publication
(10) Pub. No.: US 2012/0050347 A1
(43) Pub. Date: Mar. 1, 2012

(54) DISPLAY DEVICE INCLUDING DISPLAY ELEMENT HAVING MEMORABILITY

(75) Inventors: Masaki NOSE, Kawasaki (JP); Tomohisa Shingai, Machida (JP)

(73) Assignee: FUJITSU LIMITED, Kawasaki (JP)

(21) Appl. No.: 13/212,492

(22) Filed: Aug. 18, 2011

(30) Foreign Application Priority Data
Aug. 31, 2010 (JP) 2010-194777

(51) Int. Cl. G09G 5/10

(52) U.S. Cl. 345/690

(57) ABSTRACT

A display device includes a display element that maintains its display state even when no longer driven; a capacitance detecting circuit that detects a capacitance of the display element; and a driving condition adjusting circuit that drives the display element under predetermined driving conditions to set the display element to the display state, and that adjusts driving conditions for the display element on the basis of the capacitance of the display element exhibiting the display state detected by the capacitance detecting circuit.

### CROSS-REFERENCE TO RELATED APPLICATIONS

This application is based upon and claims the benefit of priority of the prior Japanese Patent Application No. 2010-194777, filed on Aug. 31, 2010 the entire contents of which are incorporated herein by reference.

### FIELD

The present invention relates to a display device including a display element having memorability (i.e, memory).

### BACKGROUND

Display devices that use a material having memorability such as a cholesteric liquid crystal have been developed and applied to electronic paper etc. Because of a difficult manufacturing process that uses a film substrate, the electronic paper tends to suffer from lot-to-lot variability in contrast, brightness, and gamma characteristics of a display element. After manufacture, a long period of use of the display element may cause variations in such characteristics. Such variability and variations over time may hinder desirable display even if the display element is driven under the same driving conditions.

Thus, it is proposed to provide the display element with a brightness sensor that detects the actual display state, for example, in order to perform adjustment such that a desired display state may be obtained. However, providing the display element with the brightness sensor may be difficult in terms of cost and appearance, and may not be preferable especially for a reflective display element that boasts of its easy portability such as electronic paper.

It is also proposed to measure the accumulated energization time for a display element that keeps energized during display in order to predict and correct variations over time. Because the electronic paper is energized during rewriting which occurs irregularly, however, correction that utilizes the accumulated energization time may not be applied to the electronic paper.

Thus, it is difficult to make the display devices free of lot-to-lot variability and variations over time in contrast, brightness, and gamma characteristics of the display element.

Related art is disclosed in Japanese Laid-open Patent Publication No. 2008-065058, and Japanese Laid-open Patent Publication No. 52-140295.

### SUMMARY

According to one aspect of the invention, a display device includes a display element that maintains its display state even when no longer driven; a capacitance detecting circuit that detects a capacitance of the display element; and a driving condition adjusting circuit that drives the display element under predetermined driving conditions to set the display element to the display state, and that adjusts driving conditions for the display element on the basis of the capacitance of the display element exhibiting the display state detected by the capacitance detecting circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a schematic configuration of a display device according to a first embodiment;

FIG. 2 illustrates the configuration of a display element used in the display device according to the first embodiment;

FIG. 3 illustrates the configuration of a single panel;

FIGS. 4A and 4B illustrate states of a cholesteric liquid crystal;

FIG. 5 illustrates exemplary voltage-reflectivity characteristics of a common cholesteric liquid crystal;

FIG. 6 illustrates a driving waveform according to a Dynamic Driving Scheme (DDS);

FIG. 7 illustrates driving waveforms output from a common driver and a segment driver in the first embodiment;

FIG. 8 illustrates a voltage waveform applied to each pixel in the first embodiment;

FIG. 9 illustrates the results of measuring the relationship between the lightness (reflectivity) and the capacitance of the cholesteric liquid crystal for three sample layers of the display element;

FIG. 10 illustrates the capacitance characteristics of the display element with respect to the frequency;

FIG. 11 illustrates the configuration of a circuit portion in a power source unit that outputs a capacitance detection signal, a current sense amplifier, and a computation unit;

FIG. 12 illustrates the waveform of the capacitance detection signal;

FIGS. 13A and 13B illustrate the results of an experiment in which the capacitance is detected using a test cell of the cholesteric liquid crystal;

FIG. 14 illustrates variations in capacitance of the display element that occur when an Evolution voltage is varied in the case where the display element is driven with the duty ratio of a Selection pulse set to a predetermined value in accordance with the DDS;

FIGS. 15A and 15B illustrate a method of adjusting the driving conditions in the display device according to the first embodiment;

FIG. 16 is a flowchart illustrating a process of automatically adjusting the driving conditions in the display device according to the first embodiment;

FIGS. 17A and 17B illustrate exemplary driving waveforms that set the display element to a white display state and a black display state, respectively;

FIGS. 18A and 18B illustrate a method of adjusting the Evolution voltage such that a measured capacitance value reaches a target capacitance value through a Newton's method;

FIG. 19 illustrates variations in Evolution voltage that occur in the case where the Newton's method is performed for respective capacitances corresponding to a 10% point and a 90% point;

FIGS. 20A to 20C illustrate a method of adjusting the Evolution voltage such that a measured capacitance value reaches a target capacitance value through a bisection method;

FIG. 21 illustrates adjustment performed in a third step;

FIG. 22 illustrates variations in duty ratio that occur in the case where the bisection method is performed to determine the duty ratio at which the capacitance corresponding to a 60% point is obtained;

FIGS. 23A and 23B illustrate a method of bringing a plurality of regions of a display screen into different display states to measure the capacitances for the respective display states;

FIGS. 24A to 24D illustrate a method of bringing a plurality of regions of a display screen into different display states to measure the capacitances for a large number of display states;

FIG. 25 illustrates the correlation between output voltages of the segment driver and the common driver in the case where a bipolar driver IC is used;

FIG. 26 illustrates variations in display state in a display device according to a second embodiment;

FIGS. 27A and 27B illustrate a reset pulse and a writing pulse with a variable pulse width, respectively, according to the second embodiment; and

FIGS. 28A to 28D illustrate a plurality of exemplary writing pulses for a case where the application time of the writing pulse is varied in accordance with the number of applied pulses according to the second embodiment.

### DETAILED DESCRIPTION OF THE EMBODIMENTS

Embodiments of the present invention will be specifically described below with reference to the drawings.

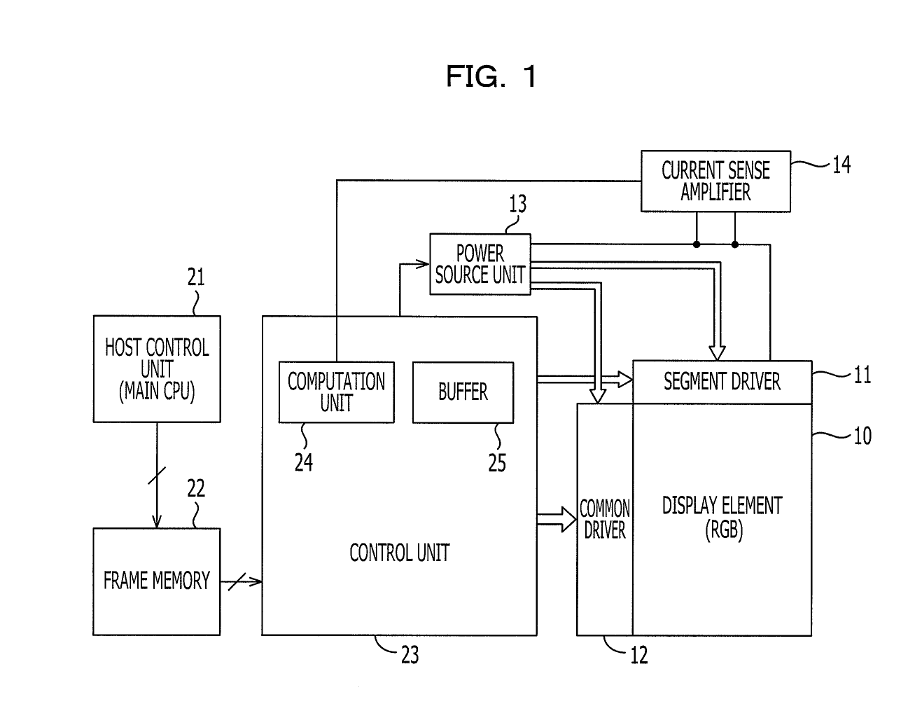

FIG. 1 illustrates a schematic configuration of a display device according to a first embodiment. The display device according to the first embodiment is electronic paper. A drive signal is applied to a display element 10 when display is to be rewritten. The display, once rewritten, is retained without application of the drive signal.

As illustrated in FIG. 1, the display device according to the first embodiment includes the display element 10 which uses a cholesteric liquid crystal, a segment driver 11, a common driver 12, a power source unit 13, a current sense amplifier 14, a host control unit 21, a frame memory 22, and a control unit 23.

The host control unit 21 includes a main CPU etc., and performs various processes on image data stored in an external storage device or image data acquired via a communication circuit or the like to obtain an image that is suitable for display on the display device. For example, in order to display halftone image data, tone conversion is performed by applying a known tone conversion technique such as an error diffusion method, an ordered dither method, or a blue noise mask method for adaptation to the number of tones that are displayable on the display device. A part of this process may be performed by the control unit 23. The host control unit 21 stores the generated image data in the frame memory 22.

The control unit 23 includes a sub CPU, a microcontroller, a PLD, or the like, and controls various units excluding the host control unit 21. The control unit 23 generates drive data in accordance with the image data read from the frame memory 22 to supply the generated drive data to the segment driver 11 and the common driver 12. In order to facilitate adjustment of the timing to supply the drive data to the segment driver 11 and the common driver 12, it is desirable that the control unit 23 include a buffer 25 that temporarily stores the generated drive data.

The display element 10 is a display element that uses a cholesteric liquid crystal and in which R, G, and B panels are stacked in three layers to enable color display. The display element 10 will be discussed in detail later. The segment driver 11 and the common driver 12 drive the display element 10 in accordance with a simple matrix scheme, and are implemented by a general-purpose driver IC. The segment driver 11 includes three drivers to independently drive the panels in the respective layers. The common driver 12 may include one driver that commonly drives the panels in the three layers.

The power source unit 13 includes a voltage boosting regulator, such as a DC-DC converter, that boosts a voltage of 3 to 5 V supplied from a common power source (not illustrated) of the display device to +50 V in case of a unipolar driver IC, and to about −25 V to +25 V in conjunction with a negative DC-DC converter in case of a bipolar driver IC. As a matter of course, it is desirable that the voltage boosting regulator have a high conversion efficiency for the characteristics of the display element. Preferably, switching of a reset voltage and a writing voltage is performed using an analog switch or a digital potentiometer. A booster circuit including an operational amplifier and a transistor and a smoothing capacitor are disposed in a stage subsequent to the switching circuit to stabilize the drive voltage of the display element 10.

The configuration described above is the same as that of a common display element that uses a cholesteric liquid crystal, and various configurations known in the art may be used. The display element 10 is not limited to a display device that uses a cholesteric liquid crystal, and may be any display element that has memorability.

In the display device according to the first embodiment, the power source unit 13 produces a capacitance detection signal, such as a saw-tooth wave signal or a triangular wave signal, in accordance with a control signal from the control unit 23 to supply the produced capacitance detection signal to a power source terminal of the segment driver 11. Preferably, the power source terminal is not used for writing or the like. The power source unit 13 may adjust the voltage to be supplied to the segment driver 11 and the common driver 12 in accordance with the control signal from the control unit 23.

In the display device according to the first embodiment, further, the current sense amplifier 14 is disposed to detect a current through a signal line for supplying the capacitance detection signal from the power source unit 13 to the segment driver 11. The current detected when the capacitance detection signal is applied to the display element 10 is related to the capacitance of the display element 10. The current sense amplifier 14 outputs a detection signal to the computation unit 24.

The control unit 23 executes a driving condition adjusting mode when the display device is started and in response to a command from a user. The driving condition adjusting mode may be automatically executed immediately when the display device is used for the first time, such as after product shipment, and thereafter may be automatically executed regularly, for example at a frequency of about once a month. The control unit 23 sets the display element 10 to a predetermined display state, causes the power source unit 13 to apply the capacitance detection signal to the display element 10, and causes the computation unit 24 to digitize the detection signal from the current sense amplifier 14 and take the digitized detection signal as detection data. The computation unit 24 acquires the detection data while changing the display state of the display element 10 in accordance with a driving condition adjusting sequence to be discussed later to determine driving conditions for desired display. After the driving condition adjusting mode is finished, the control unit 23 controls the various units under the determined driving conditions.

Next, a display device that uses a cholesteric liquid crystal, which is used as the display device 10 in the display device according to the first embodiment, will be described.

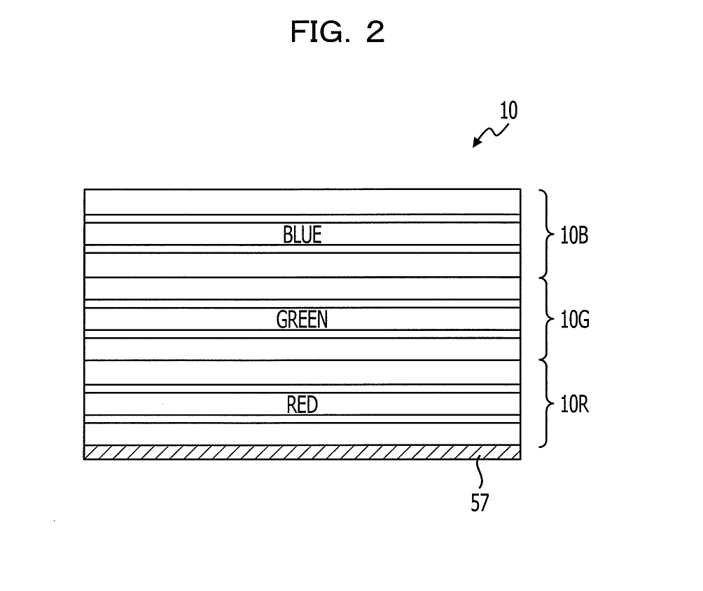

FIG. 2 illustrates the configuration of the display element 10 used in the display device according to the first embodiment. As illustrated in FIG. 2, the display element 10 includes three panels stacked on each other in the order of a panel 10B for blue color, a panel 10G for green color, and a panel 10R for red color from the side from which the display element 10 is seen, and a light absorbing layer 57 provided under the panel 10R for red color. Although the panels 10B, 10G, and 10R have the same configuration as each other, their liquid crystal material and chiral material are selected and the content of their chiral material is determined such that the panel 10B reflects light around a wavelength of blue color (about 480 nm), the panel 10G reflects light around a wavelength of green color (about 550 nm), and the panel 10R reflects light around a wavelength of red color (about 630 nm). Scan electrodes and data electrodes of the panels 10B, 10G, and 10R are driven by the common driver 12 and the segment driver 11.

The panels 10B, 10G, and 10R have the same configuration as each other except that they reflect light around wavelengths that are different from each other. The configuration of a typical example of the panels 10B, 10G, and 10R, which is referred to as a panel 10A, will be described below.

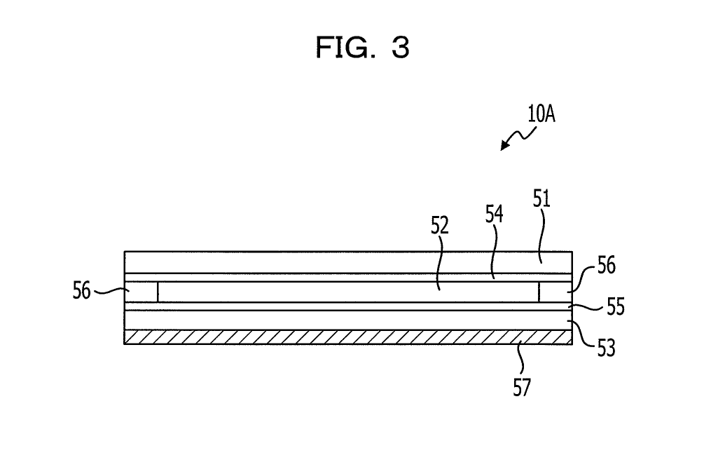

FIG. 3 illustrates the basic configuration of a single panel 10A.

As illustrated in FIG. 3, the display element 10A includes an upper substrate 51, an upper electrode layer 54 provided on a surface of the upper substrate 51, a lower substrate 53, a lower electrode layer 55 provided on a surface of the lower substrate 53, and a sealing material 56. The upper substrate 51 and the lower substrate 53 are disposed such that the electrodes face each other. A liquid crystal material is injected between the electrodes of the upper substrate 51 and the lower substrate 53 to be sealed by the sealing material 56. A spacer (not illustrated) is disposed in a liquid crystal layer 52. A voltage pulse signal is applied to the electrodes of the upper electrode layer 54 and the lower electrode layer 55 so that a voltage is applied to the liquid crystal layer 52. Applying a voltage to the liquid crystal layer 52 brings liquid crystal molecules in the liquid crystal layer 52 into a planar state or a focal conic state for display. A plurality of scan electrodes and a plurality of data electrodes are formed in the upper electrode layer 54 and the lower electrode layer 55.

The upper substrate 51 and the lower substrate 53 may both be translucent. However, the lower substrate 53 of the panel 10R may be non-translucent. Examples of the translucent substrate include a glass substrate. Besides the glass substrate, a film substrate made of PET (polyethylene terephthalate), PC (polycarbonate), or the like may also be used.

Typical examples of the material of the electrodes of the upper electrode layer 54 and the lower electrode layer 55 include Indium Tin Oxide (ITO). Besides, a transparent conductive film made of Indium Zinc Oxide (IZO) or the like may also be used.

The transparent electrode of the upper electrode layer 54 is formed on the upper substrate 51 as a plurality of upper belt-like transparent electrodes that are parallel to each other. The transparent electrode of the lower electrode layer 55 is formed on the lower substrate 53 as a plurality of lower belt-like transparent electrodes that are parallel to each other. The upper substrate 51 and the lower substrate 53 are disposed such that the upper electrodes and the lower electrodes cross each other as seen from a direction that is perpendicular to the substrates. Pixels are formed at the crossing points. An insulating thin film is formed on the electrodes. If the thin film is thick, it is necessary to increase the drive voltage. Conversely, absence of the thin film causes a flow of a leak current, which may reduce the accuracy of automatic adjustment according to the present invention. In the example, the relative dielectric constant of the thin film is about 5, which is considerably lower than that of the liquid crystal. Therefore, the thickness of the thin film is preferably about 0.3 μm or less.

The insulating thin film may be formed by a thin film of SiO₂, or an organic film made of a polyimide resin, an acrylic resin, or the like known as an orientation stabilizing film.

As described above, a spacer is disposed in the liquid crystal layer 52 to make the spacing between the upper substrate 51 and the lower substrate 53, that is, the thickness of the liquid crystal layer 52, constant. In general, the spacer is formed by spherical bodies made of a resin or an inorganic oxide. However, a fixed spacer formed by coating a surface of a substrate with a thermoplastic resin may also be used. The cell gap formed by the spacer is preferably in the range of 4 μm to 6 μm. If the cell gap is smaller than this range, the reflectivity may be reduced to result in a dark display, and a high threshold abruptness may not be expected. Conversely, if the cell gap is larger than this range, the drive voltage may be increased to make driving by general-purpose parts difficult, although a high threshold abruptness may be retained.

The liquid crystal composition forming the liquid crystal layer 52 is a cholesteric liquid crystal obtained by adding 10 to 40% by weight (wt. %) of a chiral material to a nematic liquid crystal mixture. The amount of the chiral material to be added is defined with the total amount of the nematic liquid crystal component and the chiral material defined as 100 wt. %.

Various nematic liquid crystals known in the art may be used. However, a liquid crystal material with a dielectric constant anisotropy (Δ∈) in the range of 15 to 35 is desirable. A dielectric constant anisotropy of 15 or less generally increases the drive voltage, which makes it difficult to use general-purpose parts in a drive circuit.

On the other hand, a dielectric constant anisotropy of 25 or more may reduce the threshold abruptness, and further may reduce the reliability of the liquid crystal material itself.

Meanwhile, a refractive index anisotropy (Δn) of 0.18 to 0.24 is desirable. A refractive index anisotropy less than this range may reduce the reflectivity in the planar state. A refractive index anisotropy more than this range may significantly increase scatter reflection in the focal conic state, and may result in a high viscosity to reduce the response speed.

Next, bright and dark (white and black) display on the display device which uses a cholesteric liquid crystal material will be described. Display on the display device which uses a cholesteric liquid crystal is controlled in accordance with the state of orientation of the liquid crystal molecules.

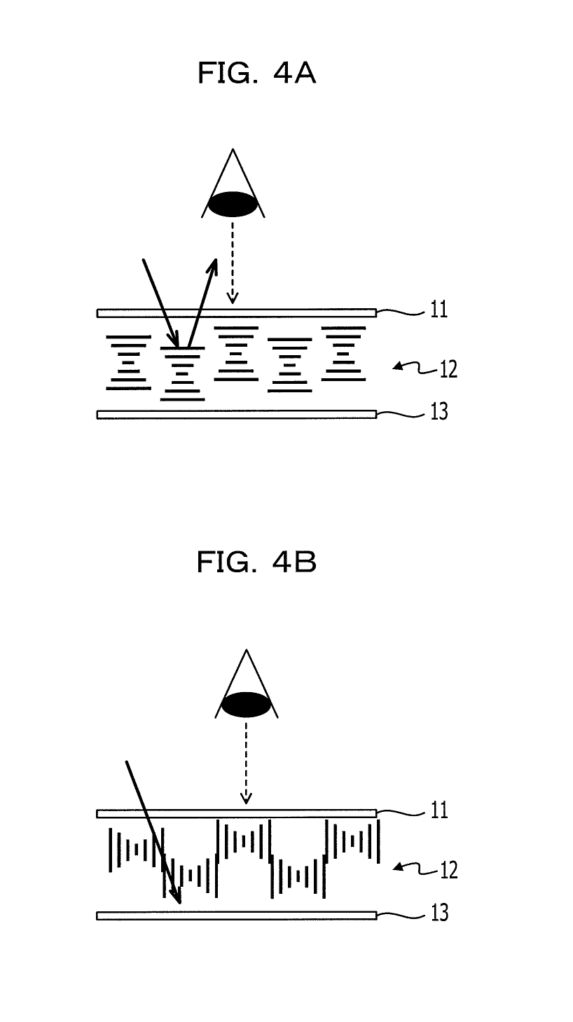

FIGS. 4A and 4B illustrate states of the cholesteric liquid crystal. The cholesteric liquid crystal takes the planar state in which incident light is reflected as illustrated in FIG. 4A and the focal conic state in which incident light is reflected as illustrated in FIG. 4B. These states are stably retained even under no electric field. Besides, the cholesteric liquid crystal is brought into a homeotropic state, in which all the liquid crystal molecules are oriented in accordance with the direction of an electric field, when a strong electric field is applied. When the application of the electric field is stopped, however, the cholesteric liquid crystal is brought from the homeotropic state into the planar state or the focal conic state.

In the planar state, light at a wavelength corresponding to the helical pitch of the liquid crystal molecules is reflected. A wavelength λ with maximum reflection is represented by the following formula using an average refractive index n and a helical pitch p of the liquid crystal.

λ=n·p

Meanwhile, a reflection band Δλ increases along with a refractive index anisotropy Δn of the liquid crystal.

In the planar state, incident light is reflected, and thus a “bright” state, that is, white, is displayed. In the focal conic state, on the other hand, light having passed through the liquid crystal layer is absorbed by the light absorbing layer provided under the lower substrate 53, and thus a “dark” state, that is, black, is displayed. A halftone state that falls between the “bright” state (white display) and the “dark” state (black display) is established with the planar state and the focal conic state coexisting with each other. The halftone level is determined by the ratio of the planar state and the focal conic state coexisting with each other.

Next, a method of driving the display element which uses a cholesteric liquid crystal will be described.

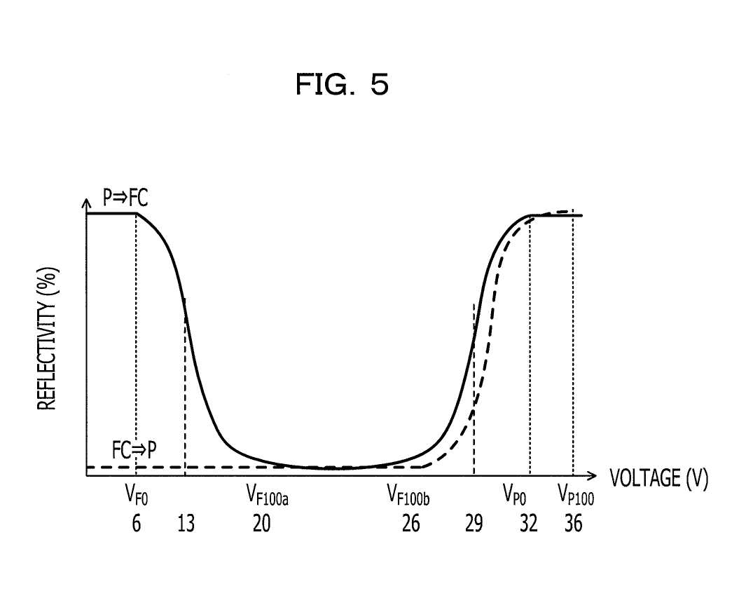

FIG. 5 illustrates exemplary voltage-reflectivity characteristics of a common cholesteric liquid crystal. The horizontal axis represents the voltage value (V) of a pulse voltage applied with a predetermined pulse width between the electrodes sandwiching the cholesteric liquid crystal. The vertical axis represents the reflectivity (%) of the cholesteric liquid crystal. In FIG. 5, a solid curve P indicates the voltage-reflectivity characteristics of a cholesteric liquid crystal that is initially in the planar state, and a broken curve FC indicates the voltage-reflectivity characteristics of a cholesteric liquid crystal that is initially in the focal conic state.

When a strong electric field (at V_{P100} or higher) is produced in the cholesteric liquid crystal, the helical structure of the liquid crystal molecules is completely disrupted during the application of the electric field to establish the homeotropic state in which all the molecules are orientated in accordance with the direction of the electric field. Next, if the application voltage is abruptly reduced from V_{P100} to substantially zero when the liquid crystal molecules are in the homeotropic state, the helical axis of the liquid crystal becomes vertical with respect to the electrodes to establish the planar state in which light corresponding to the helical pitch is selectively reflected.

On the other hand, in the case where a weak electric field (in the range of V_{F100a} to V_{F100b}) that does not disrupt the helical structure of the cholesteric liquid crystal particles is applied and thereafter removed, or in the case where a strong electric field is applied and thereafter removed slowly, the helical axis of the cholesteric liquid crystal molecules becomes parallel to the electrodes to establish the focal conic state in which incident light is reflected.

If an electric field with an intermediate strength (V_{F0} to V_{F100a} or V_{F100b} to V_{P0}) is applied and thereafter moved abruptly, a halftone image may be displayed with the planar state and the focal conic state coexisting with each other.

Display is made utilizing the above phenomena.

A simple matrix type display device that uses a cholesteric liquid crystal uses a Dynamic Driving Scheme (DDS) for high-speed rewriting. The display device according to the first embodiment also uses the DDS to display a halftone image. Before rewriting an image, a reset operation may be performed to bring all the pixels into the planar state at the same time. The reset operation is performed by forcibly setting all the outputs of the segment driver 11 and the common driver 12 to respective predetermined values. The reset operation does not require transfer of data for setting the output values, and thus may be executed in a short time. Because power is consumed, the reset operation may not be performed for low power consumption devices.

In order to facilitate description, display of a black-and-white binary image will first be described.

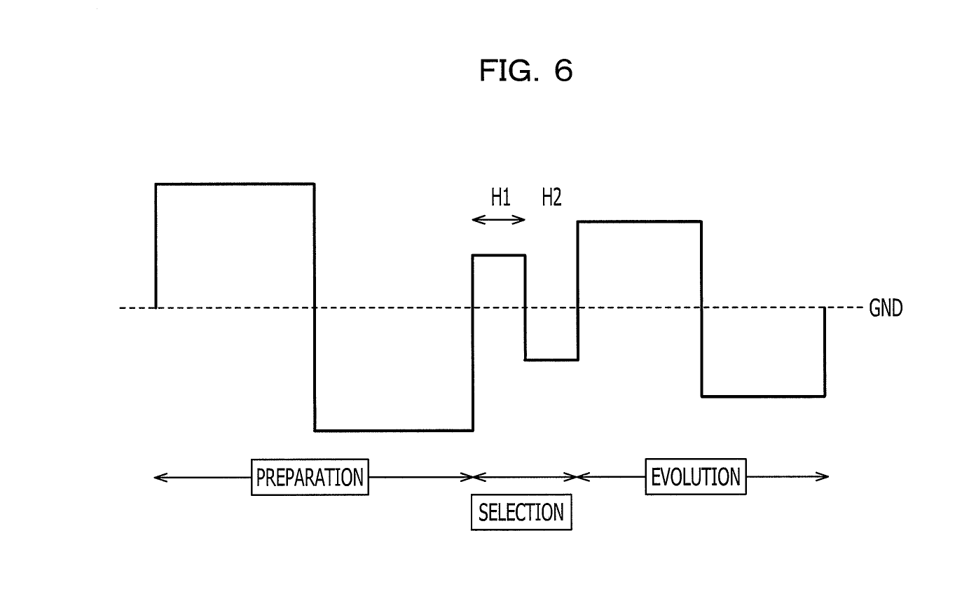

FIG. 6 illustrates a driving waveform according to the DDS.

As discussed earlier, the DDS roughly includes three stages, namely a “Preparation” period, a “Selection” period, and an “Evolution” period, which are arranged in this order from the beginning. A Non-Select period is provided before and after these periods. In the Preparation period, the liquid crystal is initialized into the homeotropic state, and a Preparation pulse at a high voltage and with a large pulse width is applied. In the Selection period, a trigger for a branch into the planar state or the focal conic state is provided. In the Selection period, a Selection pulse at a low voltage and with a small pulse width is applied to switch into the planar state, and no pulse is applied to switch into the focal conic state. In the Evolution period, a determination is made on the planar state or the focal conic state depending on the transient state in the preceding Selection period, and an Evolution pulse at an intermediate voltage and with a large pulse width is applied. Each of the Preparation pulse, the Selection pulse, and the Evolution pulse includes a set of positive and negative pulses.

In the Preparation period and the Evolution period, in practice, a plurality of sets of positive and negative Preparation pulses, or Evolution pulses, are applied, rather than a single set of positive and negative pulses with a large pulse width such as those illustrated in FIG. 6.

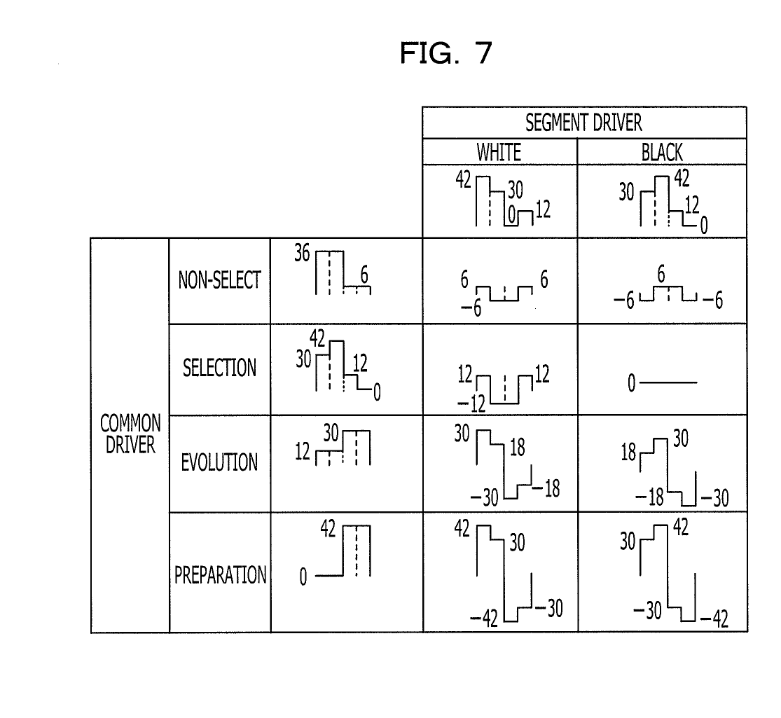

FIG. 7 illustrates respective driving waveforms output from the common driver 12 in the Preparation period, the Selection period, the Evolution period, and the Non-Select period, respective driving waveforms output from the segment driver 11 for white display and black display, and respective waveforms applied to the liquid crystal according to the first embodiment.

In the case where the DDS is executed in the first embodiment, the common driver 12 outputs six values including GND, and the segment driver 11 outputs four values including GND. Currently, general-purpose driver ICs for the simple matrix scheme have been put into practical use, and may be used as the segment driver 11 or the common driver 12 through mode setting. Thus, the general-purpose driver IC utilized as the segment driver 11 has redundant outputs. In the first embodiment, the redundant outputs of the segment driver 11 are utilized to apply a capacitance detection signal to the display device 10.

The common driver 12 and the segment driver 11 vary their outputs in each quarter of the Selection period. The segment driver 11 outputs a voltage waveform that varies in the order of 42 V, 30 V, 0 V, and 12 V for white display and a voltage waveform that varies in the order of 30 V, 42 V, 12 V, and 0 V for black display. The common driver 12 outputs a voltage waveform that varies in the order of 36 V, 36 V, 6 V, and 6 V in the Non-Select period, a voltage waveform that varies in the order of 30 V, 42 V, 12 V, and 0 V in the Selection period, a voltage waveform that varies in the order of 12 V, 12 V, 30 V, and 30 V in the Evolution period, and a voltage waveform that varies in the order of 0 V, 0 V, 42 V, and 42 V in the Preparation period.

Accordingly, in the Preparation period, a voltage waveform that varies in the order of 42 V, 30 V, −42 V, and −30 V is applied to the liquid crystal of the data electrode for white display, and a voltage waveform that varies in the order of 30 V, 42 V, −30 V, and −42 V is applied to the liquid crystal of the data electrode for black display. In the Evolution period, a voltage waveform that varies in the order of 30 V, 18 V, −30 V, and −18 V is applied to the liquid crystal of the data electrode for white display, and a voltage waveform that varies in the order of 18 V, 30 V, −18 V, and −30 V is applied to the liquid crystal of the data electrode for black display. In the Selection period, a voltage waveform that varies in the order of 12 V, −12 V, −12 V, and 12 V is applied to the liquid crystal of the data electrode for white display, and a voltage waveform at 0 V is applied to the liquid crystal of the data electrode for black display. In the Non-Select period, a voltage waveform that varies in the order of 6 V, −6 V, −6 V, and 6 V is applied to the liquid crystal of the data electrode for white display, and a voltage waveform that varies in the order of −6 V, 6 V, 6 V, and −6 V is applied to the liquid crystal of the data electrode for black display.

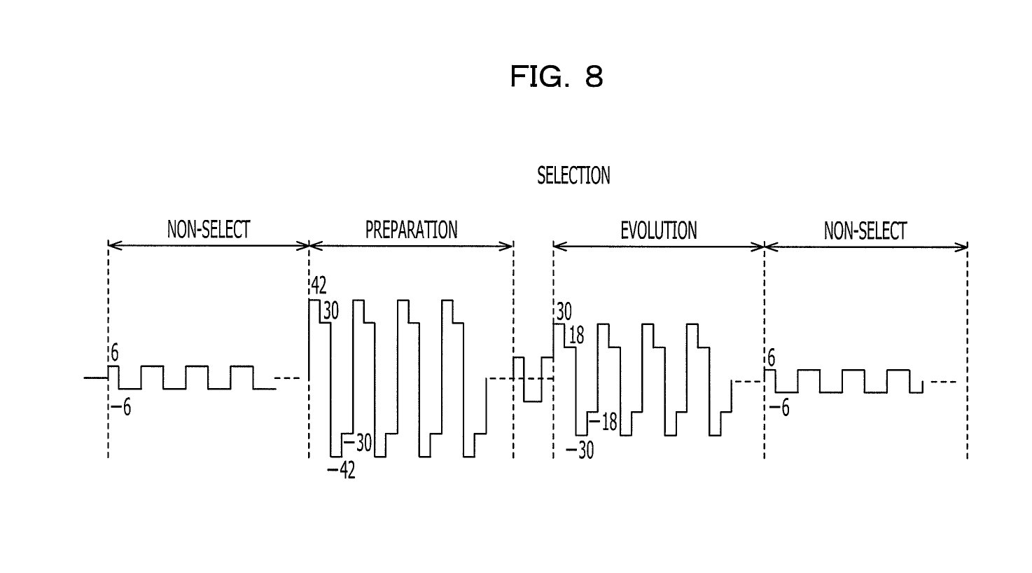

FIG. 8 more specifically illustrates a voltage waveform applied to the liquid crystal of each pixel with the common driver 12 and the segment driver 11 outputting the driving waveforms illustrated in FIG. 7 in the first embodiment. The voltage waveform of FIG. 8 is applied to each scan line. The common driver 12 shifts the scan line to which the signal of FIG. 8 is applied one by one.

As illustrated in FIG. 8, the periods discussed above are disposed in the order of the Preparation period, the Selection period, and the Evolution period with the Non-Select period disposed before and after the three periods. The Selection period extends over about 0.5 ms to 1 ms. In FIG. 8, a Selection pulse at ±12 V for a case where the planar state is established for white display (bright display) is illustrated. In the case where the focal conic state is established for black (dark display), 0 V is applied during this period.

In the Preparation period and the Evolution period, which extend over several to a dozen or so times the duration of the Selection period, a plurality of the Preparation pulses, or the Evolution pulses, of FIG. 7 are applied. In the Non-Select period, pulses at a low voltage are constantly applied to pixels not related to image rendering, which causes no change in image.

The set of the Preparation pulse, the Selection pulse, and the Evolution pulse of FIG. 8 is sequentially applied to the scan line at changing positions. This allows scan and rewriting to be performed in a pipeline manner in a time for application of the Selection pulse per one line with the Selection pulse accompanying the Preparation pulse and the Evolution pulse. Therefore, even a high-definition display element according to XGA specifications may be rewritten in around 0.77 seconds (=1 ms×768).

In order to display a halftone image, the Selection period is further divided into a plurality of sub periods so that the driving waveform illustrated in FIG. 7 may be applied in each of the sub periods. The ratio of sub periods for white display and sub periods for black display, of the plurality of sub periods, is varied. If eight sub periods are provided, for example, the duty ratio is 100% in the case where all the eight sub periods perform white display, 0% in the case where all the eight sub period perform black display, and 25% in the case where two of the sub periods perform white display. In the first embodiment, the Selection period extends over about 700 μs, which is divided into sub periods each extending over 20 to 30 μs. Thus, as many as 23 to 35 sub periods are provided. If the sub periods for white display are disposed centrally of the Selection period, the width of the Selection pulse for white display in the Selection period varies in accordance with the duty ratio. Hereinafter, in order to simplify description, it is assumed that the width of the Selection pulse in the Selection period varies in accordance with the duty ratio using the DDS driving waveform illustrated in FIG. 6.

As discussed earlier, a display device that uses a liquid crystal having memorability tends to suffer from lot-to-lot variability in contrast, brightness, and gamma characteristics of a display element, and a long period of the display element may cause variations in such characteristics. Such variability and variations over time in the display element may hinder desirable display even if the display element is driven under the same driving conditions. In particular, the DDS used by the display device according to the first embodiment is narrow in optimum range of the driving conditions, and thus is significantly affected by the variability and variations over time in the display element. Therefore, good display may not be obtained under fixed driving conditions.

In order to adjust the driving conditions, the characteristics of the display element related to display (brightness) are detected to perform adjustment on the basis of the relationship of the detected characteristics with the display (brightness). As discussed earlier, it has been proposed to determine the driving conditions in accordance with the capacitance value. Also in the display device according to the first embodiment, the capacitance of the display element 10 is detected to adjust the driving conditions so as to achieve desirable driving conditions. In the display device according to the first embodiment, however, the capacitance of the display element 10 is directly detected without using a dummy cell, and detection of the capacitance and adjustment of the driving conditions are performed with the display element 10 set to a predetermined display state (white, black, or a halftone level).

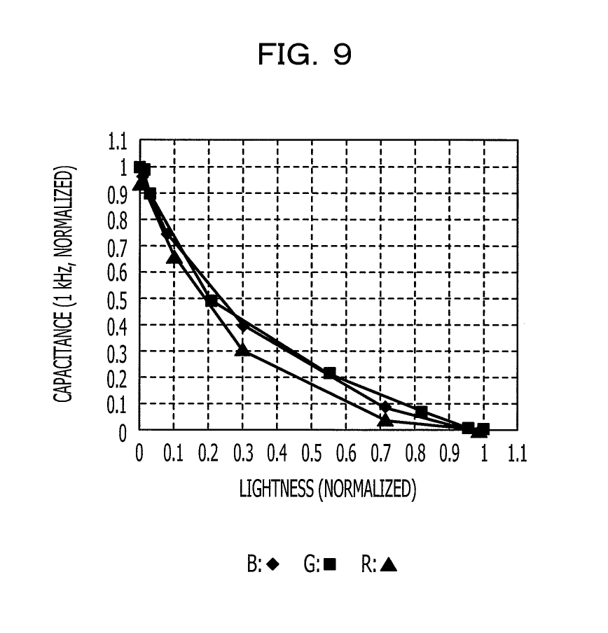

FIG. 9 illustrates the results of measuring the relationship between the lightness (reflectivity) and the capacitance for each of the R, G, and B layers of the display element 10. The capacitance is measured at 1 kHz, and represented by a relative value normalized with the lightness in the completely planar state defined as 1 and the lightness in the completely focal conic state defined as 0. Between the capacitance values of 0 and 1, halftone is displayed with the planar state and the focal conic state coexisting with each other.

As is clear from FIG. 9, the capacitance is at a maximum in the focal conic state (with a lightness of 0), and is monotonically reduced toward the planar state (with a lightness of 1). Consequently, it is found that in the case where a desired display may not be obtained because of lot-to-lot variability and variations over time, variations in lightness due to the variability and the variations over time may be estimated on the basis of the relative relationship of the capacitance. Thus, in the display device according to the first embodiment, the capacitance of the display element 10 is measured to adjust the driving conditions on the basis of the measured capacitance.

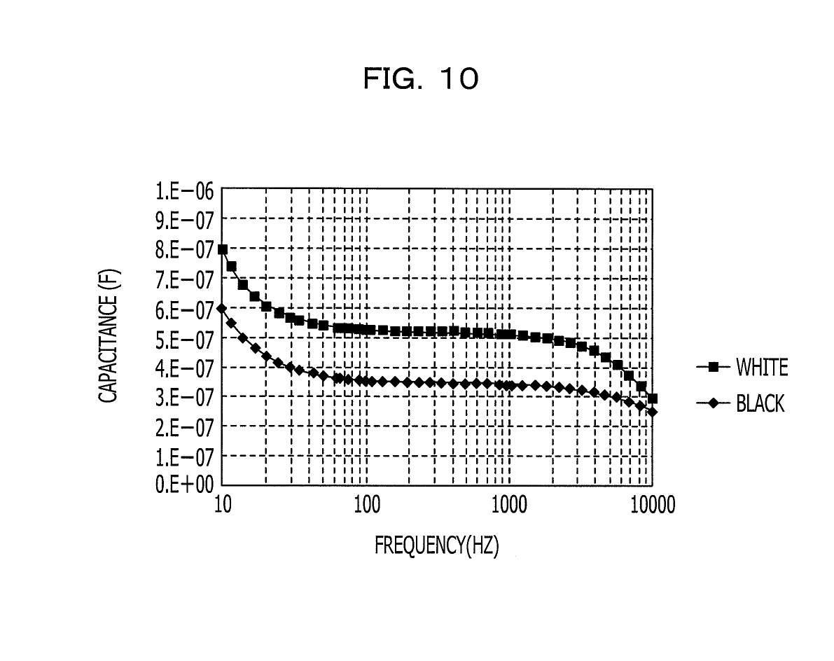

FIG. 10 illustrates the capacitance characteristics of the display element 10 with respect to the frequency. In FIG. 10, the capacitance in the focal conic state is larger than that in the planar state at frequencies up to about 10 kHz. Meanwhile, the absolute value of the capacitance becomes larger at low frequencies of 100 Hz or less. This is considered to be because of polarization due to polar groups or ion components contained in the liquid crystal material. In consideration of the ratio of the respective capacitances in the planar state and the focal conic state and the amount of current to be detected, use of a frequency of around 1 kHz is considered to be preferable to detect the capacitance.

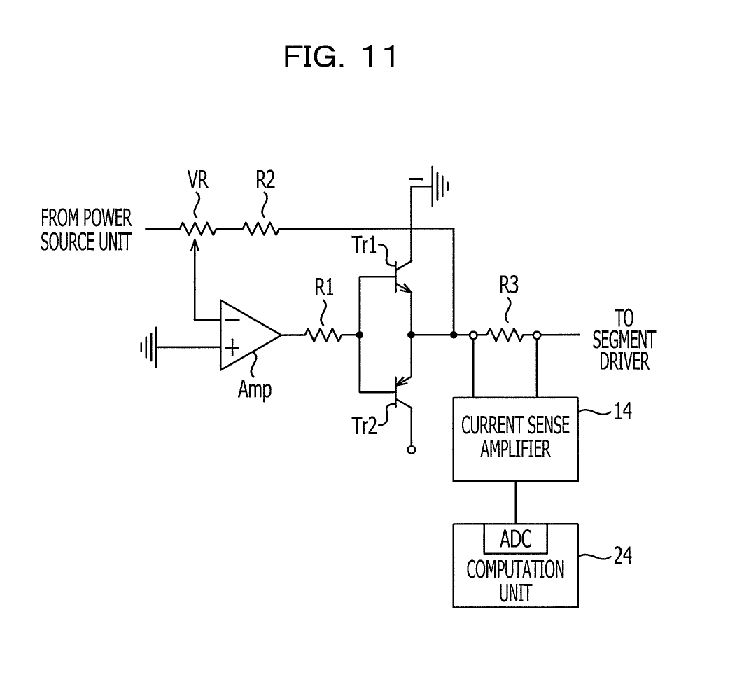

FIG. 11 illustrates the configuration of a circuit portion in the power source unit 13 that outputs a capacitance detection signal, the current sense amplifier 14, and the computation unit 24. The current sense amplifier 14 may be a general-purpose amplifier with easy input and output. The power source unit 13 produces a saw-tooth wave or a triangular wave using a D/A converter (not illustrated) to apply an original detection signal to one end of a variable resistor VR. A booster circuit including an operational amplifier Amp, a resistor R1, and transistors Tr1 and Tr2 and a resistor R2 form an amplification circuit that amplifies the original detection signal to output a capacitance detection signal in order to stabilize the output voltage. The amplification rate of the amplification circuit is adjustable by adjusting the resistance value of the variable resistor VR. The resistance value of the variable resistor VR is adjustable by adjusting the number of resistors to be connected using a switch, for example, in accordance with a control signal from the control unit 23 or the like. If it is not necessary to adjust the wave height of the capacitance detection signal, the variable resistor VR may be replaced with a fixed resistor. A damping resistor R3 that restricts current is disposed in a stage subsequent to the booster circuit. In FIG. 11, the damping resistor R3 is used also as a sensing resistor for the current sense amplifier 14. As discussed earlier, one end of the damping resistor R3 is connected to an unused power source terminal of the segment driver 11.

The current sense amplifier 14 may be an amplifier that outputs the detected current value as an analog voltage value. The voltage of the voltage signal output from the current sense amplifier 14 is digitized by an A/D converter (ADC) in the computation unit 24 to be used in computation of a capacitance value. Providing a low-pass filter having an appropriate cut-off frequency between the output of the current sense amplifier 14 and the A/D converter further improves the detection accuracy.

The power source unit 13 generates respective voltages to be supplied to the segment driver 11 and the common driver 12 using a voltage dividing circuit. Because the DDS momentarily consumes a large current, it is desirable that the respective voltages formed by the voltage dividing circuit of the power source unit 13 be output via the booster circuit including the operational amplifier Amp and the transistors Tr1 and Tr2 illustrated in FIG. 11.

Further, at terminals of the power source unit 13 that output voltages to be supplied to the segment driver 11 and the common driver 12, a smoothing capacitor with a capacitance of about several μF is often provided in a stage subsequent to the damping resistor. At a terminal that outputs a capacitance detection signal illustrated in FIG. 11, however, it is desirable that no such smoothing capacitor be provided. This is because providing a smoothing capacitor would result in detection of the combined capacitance of the capacitance of the display element and the capacitance of the smoothing capacitor, which would reduce the difference among detection values of the capacitances for white display, black display, and halftone display to reduce the S/N ratio and hence the detection accuracy.

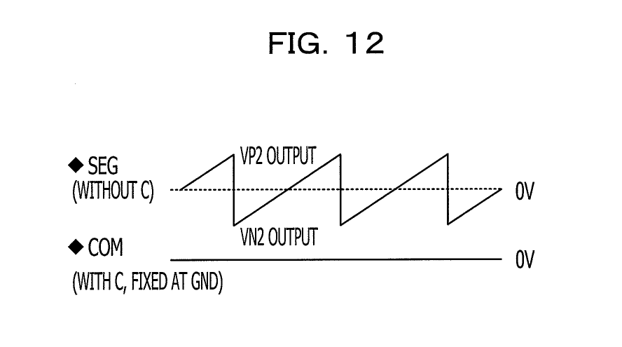

FIG. 12 illustrates the waveform of the capacitance detection signal supplied from the booster circuit to the unused power source terminal of the segment driver 11 via the damping resistor R3. In the first embodiment, a saw-tooth wave capacitance detection signal whose voltage varies in the range of ±5 V is used. In the case where the capacitance detection signal is applied to the display element, the common driver 12 is set to output a GND level to all the terminals, and the segment driver 11 is set to output to all the terminals the voltage of a terminal to which the capacitance detection signal is applied. In this state, if the capacitance detection signal is varied as illustrated in FIG. 12, a voltage that varies in the shape of saw-tooth wave is applied to all the pixels of the display element 10. In general, the saw-tooth wave capacitance detection signal is generated by a D/A converter. Therefore, it is desirable that a low-pass filter having an appropriate cut-off frequency be provided to smoothen the saw-tooth wave capacitance detection signal.

The capacitance is detected by the current sense amplifier 14 detecting the current value during charge/discharge that occurs along with application of the capacitance detection signal to the display element 10.

It is found that use of the saw-tooth wave capacitance detection signal allows stable detection of the current during charge/discharge even for the cholesteric liquid crystal, which is poorer in capacitance characteristics than a TFT liquid crystal.

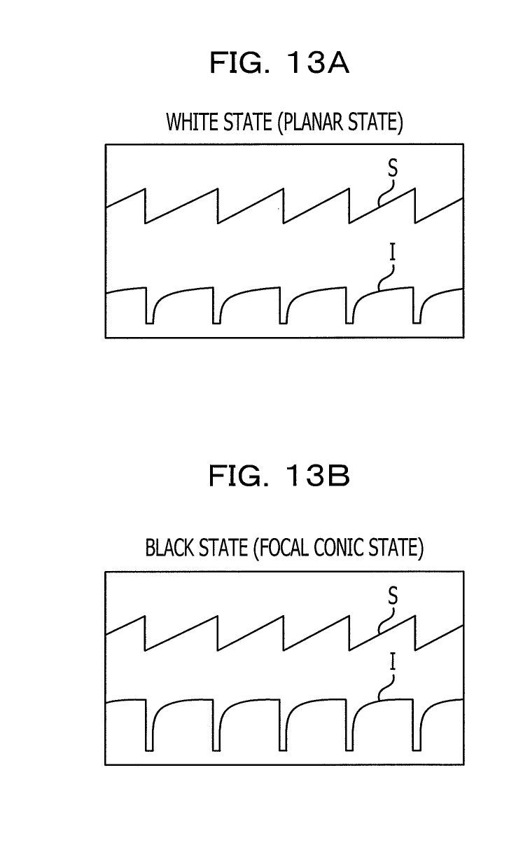

FIGS. 13A and 13B illustrate the results of an experiment in which the capacitance is detected by the circuit configuration of FIG. 11 using a test cell of the cholesteric liquid crystal. FIG. 13A illustrates a saw-tooth wave capacitance detection signal S and a current I during charge/discharge that occurs along with application of the capacitance detection signal S with all the pixels in the white display state (planar state). FIG. 13B illustrates a saw-tooth wave capacitance detection signal S and a current I during charge/discharge that occurs along with application of the capacitance detection signal S with all the pixels in the black display state (focal conic state). In FIGS. 13A and 13B, the current I abruptly increases along with an increase in signal S to become substantially constant. When the current I has become constant, the ratio between the current value in the focal conic state and the current value in the planar state is about 1.4 times, and it is confirmed that the ratio substantially coincides with the ratio between the respective capacitances for black display and white display illustrated in FIG. 10.

A CR oscillation circuit was prototyped by replacing the test cell with a capacitor. The oscillation frequency of the CR oscillation circuit was measured. As a result, the oscillation frequency in the planar state was about 1.4 times that in the focal conic state, and the oscillation frequency fluctuated significantly to frequently become unstable. Consequently, for the cholesteric liquid crystal, the capacitance was detected more stably in accordance with the current during charge/discharge that occurs along with application of the saw-tooth wave capacitance detection signal than in accordance with detection of the oscillation frequency.

In the detection of the capacitance described above, the capacitance of the display element 10 during white/black display is detected. With the display element 10 brought into a halftone display state, however, the capacitance in the halftone display state may be detected. In the detection of the capacitance described above, in addition, a saw-tooth wave capacitance detection signal is used. However, a triangular wave capacitance detection signal may also be used to perform a similar measurement.

Next, a method of adjusting the driving conditions in the display device according to the first embodiment will be described.

Conditions that may be adjusted in adjusting the driving conditions for the DDS include the respective voltages of the Preparation pulse and the Evolution pulse, the voltage of the Selection pulse for white display, and the pulse width (duty ratio) of the Selection pulse. In the first embodiment, the voltage of the Evolution pulse (Evolution voltage) and the duty ratio of the Selection pulse are adjusted. The Evolution voltage is adjusted because it is a factor that strongly governs the display contrast. The duty ratio of the Selection pulse is adjusted because it is relatively easily adjustable, among factors that produce tone variations, and enables accurate adjustment.

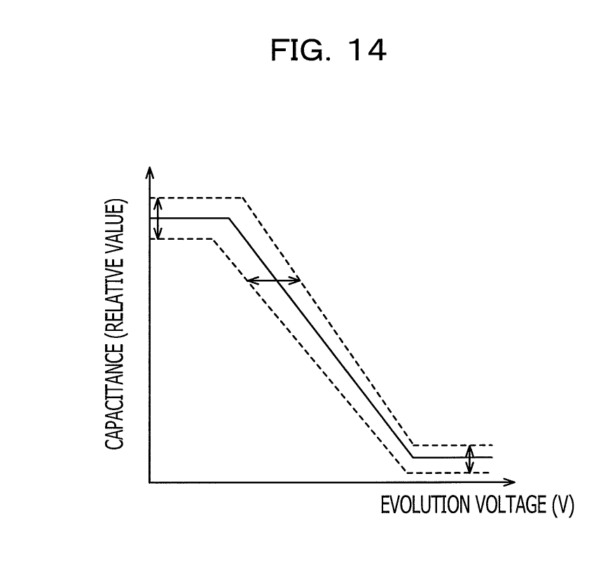

FIG. 14 illustrates variations in capacitance of the display element that occur when the Evolution voltage is varied in the case where the display element is driven in accordance with the DDS under the driving conditions described with reference to FIGS. 6 to 8 and with the duty ratio of the Selection pulse set to a predetermined value (for example, 50%).

In FIG. 14, the solid line schematically indicates an example of variations for a single display element. After being driven by an Evolution voltage that is lower than a certain value, the capacitance of the display element 10 is constant at a high value. As the Evolution voltage becomes higher, the capacitance of the display element 10 after being driven by the Evolution voltage becomes lower. After being driven by an Evolution voltage that is higher than a certain value, the capacitance of the display element 10 is constant at a low value. Such variations in capacitance fluctuate because of variability and variations over time. For example, the high and low constant capacitance values may fluctuate to become higher and lower, variations in capacitance value at an intermediate portion may vary (in the drawing, in the horizontal direction) with respect to the Evolution voltage, and the gradient of variations in capacitance value at the intermediate portion may also vary.

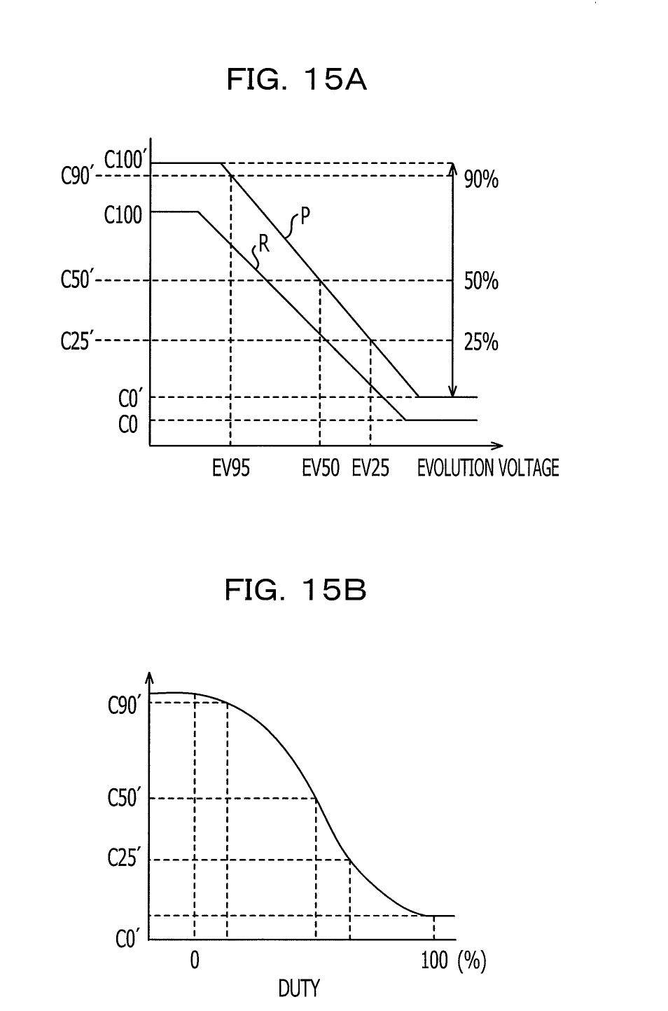

FIGS. 15A and 15B illustrate the method of adjusting the driving conditions in the display device according to the first embodiment. FIG. 15A illustrates adjustment performed in a first stage and a second stage. FIG. 15B illustrates adjustment performed in a third stage.

In FIG. 15A, R indicates a typical example of variations in capacitance of the display element that occur when the Evolution voltage is varied as illustrated in FIG. 14. The capacitance is stored in advance as a reference example. The driving conditions for R are also stored as reference driving conditions. For example, a value C100 at which the capacitance is constant at a high value and a value C0 at which the capacitance is constant at a low value may be stored. In addition, Evolution voltages at which the capacitance is at certain intermediate values, such as 25%, 50%, and 90%, in the range between C100 and C0, for example, may also be stored.

P indicates variations in capacitance, with respect to the Evolution voltage, of the display element, for which the driving conditions are to be adjusted. When the variations in capacitance P are compared with R of the reference example, C100 and C0 are increased to C100′ and C0′, respectively, the gradient at the intermediate portion is increased, and the capacitance values at 25%, 50%, 90%, etc. in the range between C100 and C0 and the corresponding Evolution voltages are increased.

In the method of adjusting the driving conditions according to the first embodiment, in the first stage, C100′ and C0′ are detected.

In the second stage, the Evolution voltage is determined such that a predetermined capacitance value (for example, 25%, 50%, 90%, etc.) in the range between C100′ and C0′ is obtained by varying the duty ratio of the Selection pulse. In other words, the Evolution voltage is determined such that generally maximum contrast and brightness may be obtained.

In the first embodiment, as described above, the Evolution voltage is varied. However, C100′ and C0′ may not be varied just by varying the Evolution voltage. For example, as illustrated in FIG. 15, if the Evolution voltage is too high, the capacitance may be C0′ even if the duty ratio of the Selection pulse is 50% or less, in which case halftone display may not be performed. If the Evolution voltage is further higher, the capacitance may become C0′ even if the duty ratio of the Selection pulse is close to 0%, in which case display may not be performed at all.

Thus, in the first embodiment, the Evolution voltage is set such that C100′ and C0′ correspond to display brightnesses of 100 and 0 (relative values), respectively, and such that variations in capacitance at a halftone portion correspond to variations in duty ratio of the Selection pulse.

In the third stage, variations in duty ratio of the Selection pulse are determined such that variations in capacitance at the halftone portion are linear.

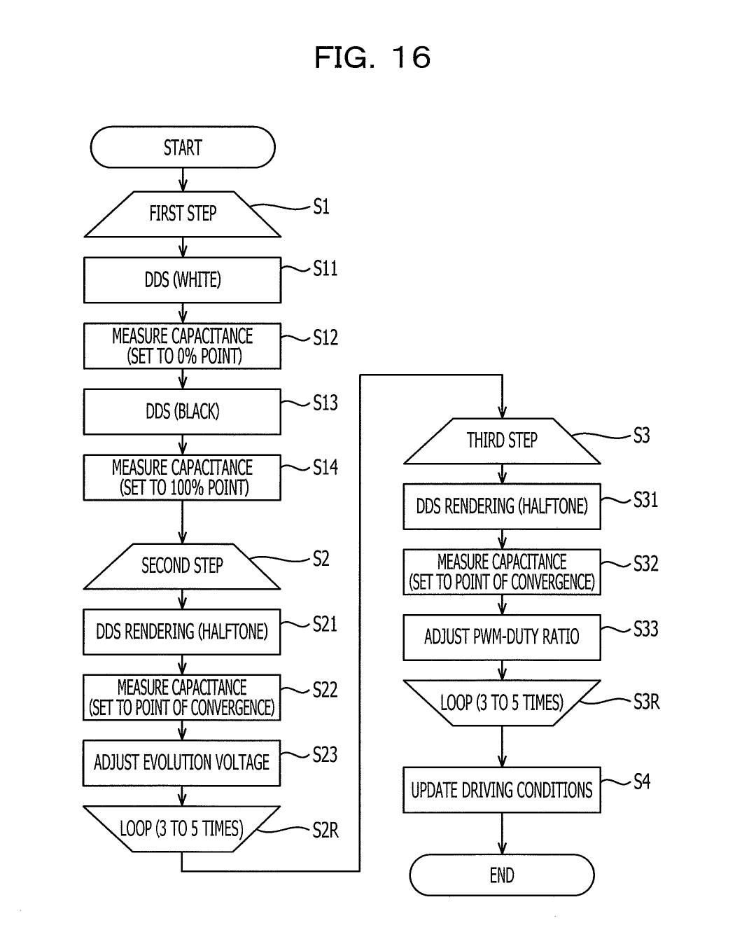

FIG. 16 is a flowchart illustrating a process of automatically adjusting the driving conditions in the display device according to the first embodiment. The process includes a first step S1, a second step S2, a third step S3, and a final step S4. In the first step S1, C0′ and C100′ described above are detected, and adapted to correspond to brightnesses of 0 and 100 (relative values), respectively. In the second step S2, the Evolution voltage is set such that a predetermined capacitance value at the halftone portion determined from C0′ and C100′ is obtained. In the third step S3, the relationship between the capacitance value at the halftone portion and the duty ratio of the Selection pulse is set in accordance with the determined Evolution voltage. In the final step S4, the driving conditions are updated in accordance with the determined Evolution voltage and the duty ratio of the Selection pulse.

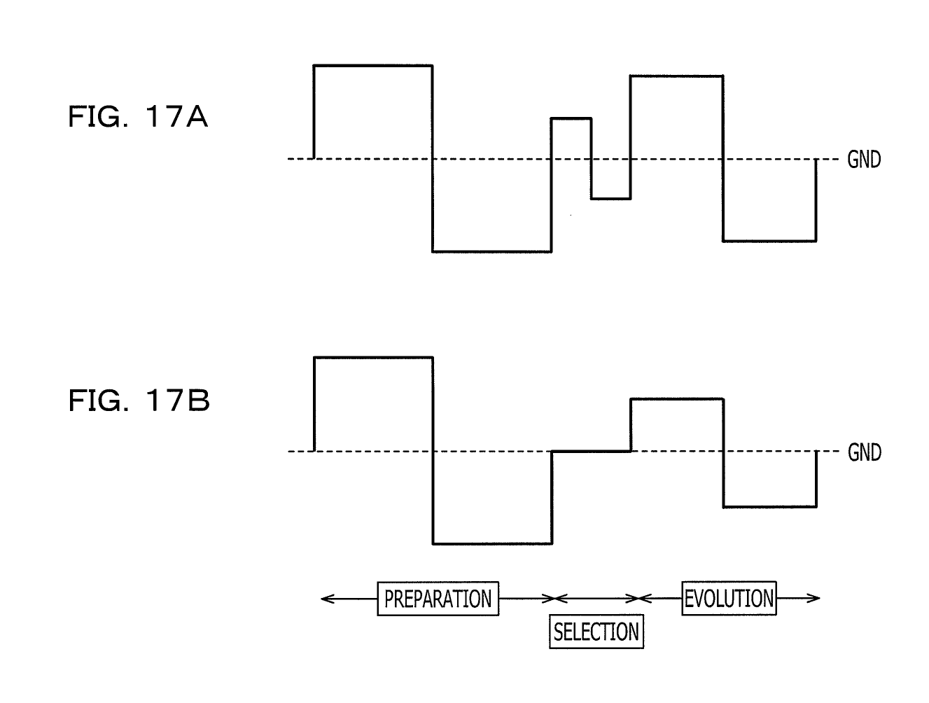

In step S11 of the first step S1, all the pixels of the display element 10 are rendered into the white display state (planar state) in accordance with the DDS. In step S11, in order to ensure that all the pixels are brought into the white display state, the duty ratio of the Selection pulse is set to 100% and, further, the Evolution voltage is set to be higher than normally as illustrated in FIG. 17A.

In step S12, the capacitance of the display element 10 in the white display state set in step S11 is measured, and the obtained value is set as a 0% point. Thus, C0′ is set as the 0% point.

In step S13, all the pixels of the display element 10 are rendered into the black display state (focal conic state) in accordance with the DDS. In step S13, in order to ensure that all the pixels are brought into the black display state, the duty ratio of the Selection pulse is set to 0% (no Selection pulse) and, further, the Evolution voltage is set to be lower than normal as illustrated in FIG. 17B.

In step S14, the capacitance of the display element 10 in the black display state set in step S13 is measured, and the obtained value is set as a 100% point. Thus, C100′ is set as the 100% point.

The second step S2 includes steps S21 to S23, which are repeated three to five times as illustrated in step S2R.

In step S21, all the pixels of the display element 10 are rendered into a halftone display state (planar state+focal conic state). The set halftone may be any tone such as 90%, 50%, and 25%. For example, in the case where the set halftone is 25%, the duty ratio of the Selection pulse is set to 25% under the driving conditions stored in advance to bring all the pixels of the display element 10 into a halftone display state in accordance with the DDS. In the case where the set halftone is 90%, the Evolution voltage is set such that generally maximum display contrast may be obtained, which is preferable in terms of display contrast.

In step S22, the capacitance of the display element 10 in the halftone display state set in step S21 is measured.

In step S23, a target capacitance value corresponding to the set halftone is calculated from the capacitances C0′ and C100′ corresponding to the 0% point and the 100% point determined in steps S12 and S14, respectively, to be compared with the measured capacitance value obtained in step S22. Then, the Evolution voltage is adjusted on the basis of the comparison results such that the measured capacitance value reaches the target capacitance value.

Steps S21 to S23 are repeated. When the measured capacitance value obtained in step S22 is approximated to the target capacitance value, step S2 is terminated to proceed to step S3.

The Evolution voltage may be adjusted by any method that adjusts the measured capacitance value to the target capacitance value. Such a method is known as a root-finding algorithm. Typical examples of the method include a Newton's method and a bisection method. Examples in which these methods are applied will be described.

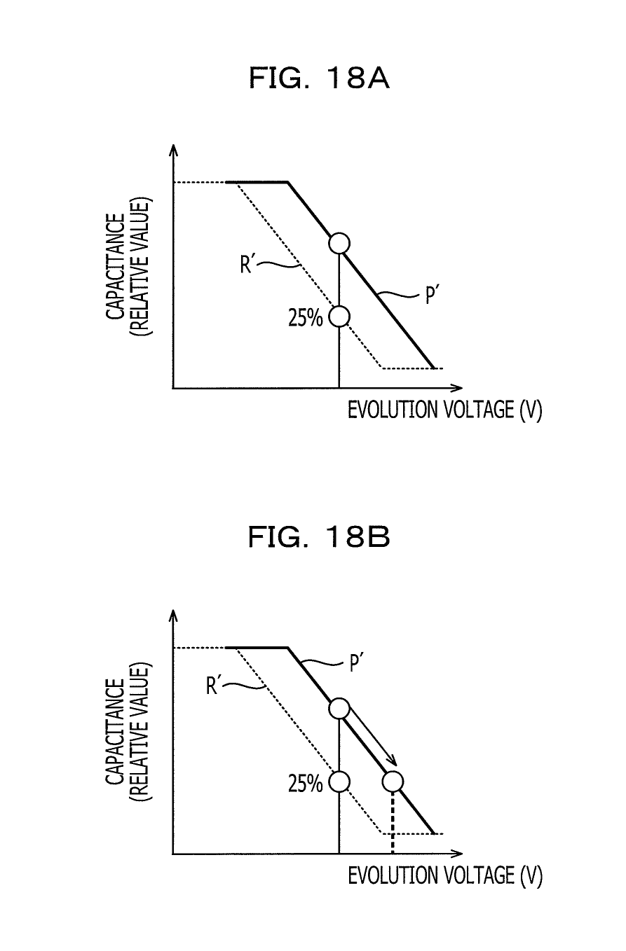

FIGS. 18A and 18B illustrate a method of adjusting the Evolution voltage such that the measured capacitance value reaches the target capacitance value through Newton's method, illustrating a case where the set halftone is 25%.

In Newton's method, standard characteristics of variation in capacitance with respect to the Evolution voltage as illustrated in FIGS. 14 and 15A are stored in advance. For convenience, the gradient and the intercept of a linear function for the characteristics may be stored. In FIGS. 18A and 18B, R′ indicates the standard capacitance variation characteristics, and P′ indicates the capacitance variation characteristics to be adjusted.

As illustrated in FIG. 18A, a standard 25% Evolution voltage on the standard capacitance variation characteristics, at which the capacitance value is 25% from C0′ (with the range between C0′ and C100′ defined as 100%), is calculated from the stored characteristics. All the pixels of the display element 10 are brought into a halftone display state in accordance with the DDS at the calculated standard 25% Evolution voltage and with the duty ratio set to 25%. The capacitance measured in this state is assumed to be 50% from C0′.

As illustrated in FIG. 18B, the amount of variation in Evolution voltage that brings the capacitance from 50% to 25% is calculated from the stored gradient, and the standard 25% Evolution voltage is varied by the calculated amount of variation. Then, similar processes are performed again using the varied Evolution voltage to bring the measured capacitance closer to the value of 25% from C0′. By repeating these processes several times, it is possible to determine the Evolution voltage at which the capacitance is approximated to the value of 25% from C0′. Although the capacitance is brought to the value of 25% from C0′, the capacitance may be brought to 50%, 90%, etc. from C0′ as discussed earlier.

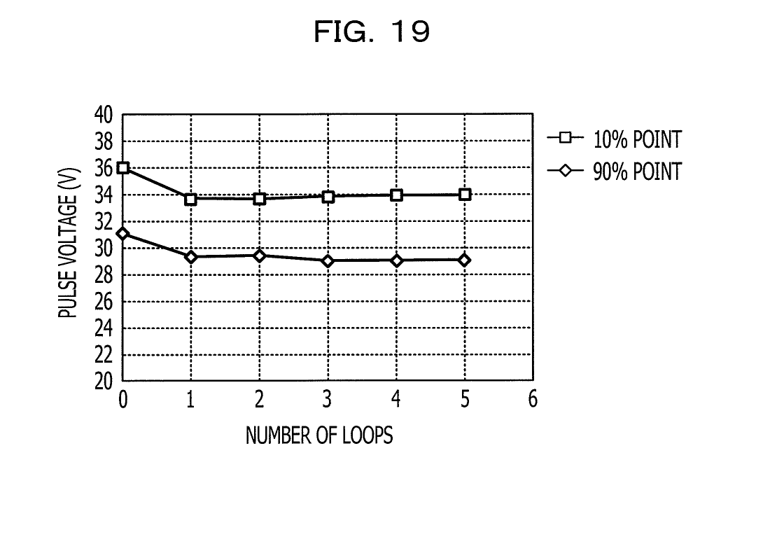

FIG. 19 illustrates variations in Evolution voltage that occur in the case where Newton's method is performed to bring the capacitance to 10% and 90% from C0′. It is found that a convergence to a substantially constant value is achieved by repeating the processes twice or three times or more.

It is known that Newton's method may result in a divergence, rather than a convergence, in the case where an object to which a solution is to be calculated has characteristics that vary very abruptly or characteristics that vary convexly and concavely. In the case where the Evolution voltage is to be adjusted, however, the capacitance varies very monotonically with respect to the Evolution voltage, and thus application of Newton's method generally reliably results in a convergence.

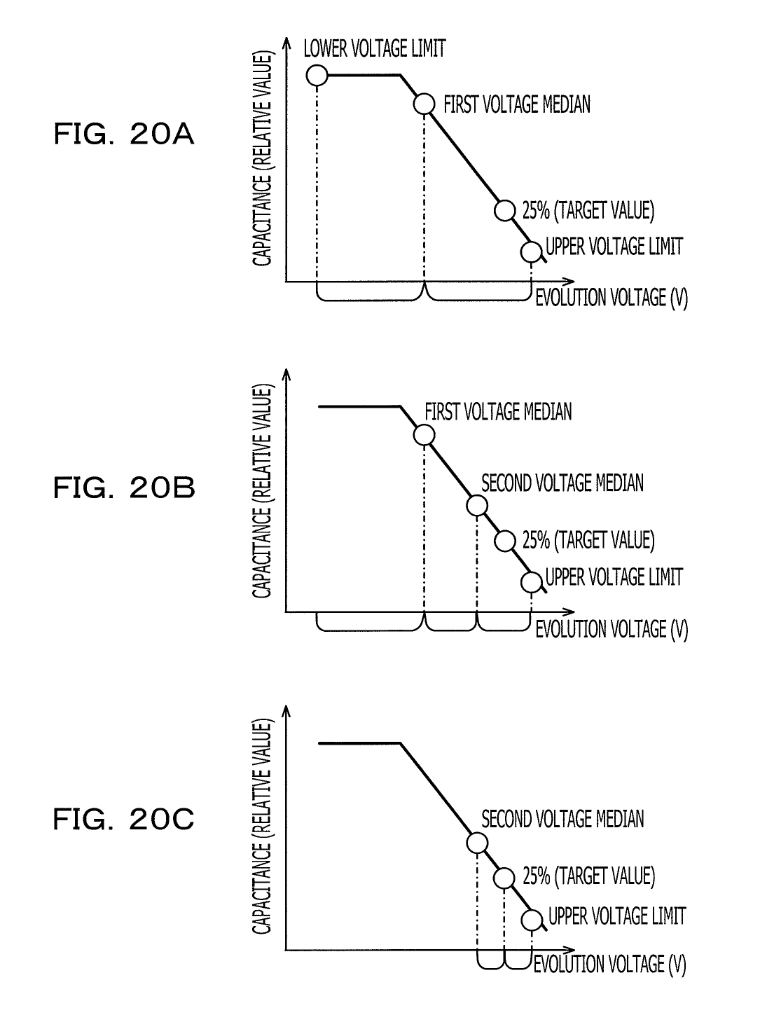

FIGS. 20A to 20C illustrate a method of adjusting the Evolution voltage such that the measured capacitance value reaches the target capacitance value through the bisection method, illustrating a case where the set halftone is 25%.

In the bisection method, it is not necessary to store standard characteristics of variation in capacitance with respect to the Evolution voltage.

As illustrated in FIG. 20A, a first voltage median is set at the middle between an upper voltage limit and a lower voltage limit of the variable range of the Evolution voltage. Then, all the pixels of the display element 10 are brought into a halftone display state in accordance with the DDS with the Evolution voltage set to the first voltage median and the duty ratio set to 25%. The capacitance measured in this state is assumed to be a value that is larger than 25% from C0′. Thus, it is determined that the first voltage median is small, and that it is necessary to increase the set value.

As illustrated in FIG. 20B, a second voltage median is set at the middle between the first voltage median and the upper voltage limit. Then, all the pixels of the display element 10 are brought into a halftone display state in accordance with the DDS with the Evolution voltage set to the second voltage median and the duty ratio set to 25%. The capacitance measured in this state is assumed to be a value that is still larger than 25% from C0′. Thus, it is determined that the second voltage median is small, and that it is necessary to increase the set value.

As illustrated in FIG. 20C, a third voltage median is set at the middle between the second voltage median and the upper voltage limit. Then, all the pixels of the display element 10 are brought into a halftone display state in accordance with the DDS with the Evolution voltage set to the third voltage median and the duty ratio set to 25%. If the capacitance measured in this state is assumed to be the value of 25% from C0′, the third voltage median is determined as the appropriate Evolution voltage.

In general, the bisection method is less likely to result in a divergence, but takes more time to achieve a convergence, than Newton's method. As described above, however, the capacitance varies very monotonically with respect to the Evolution voltage, and therefore repeating the steps five times resulted in a convergence to a generally constant value.

Returning to FIG. 16, in the third step S3, the relationship between the capacitance value at the halftone portion and the duty ratio of the Selection pulse is set using the Evolution voltage determined in step S2.

In step S31, all the pixels of the display element 10 are brought into a target halftone display state in which any of the halftones for display is displayed. This process is the same as that in step S21.

In step S32, the capacitance of the display element 10 in the target halftone display state set in step S31 is measured.

In step S33, a target capacitance value corresponding to the target halftone display state is calculated to be compared with the measured capacitance value obtained in step S32. Then, the duty ratio of the Selection pulse is determined on the basis of the comparison results such that the measured capacitance value reaches the target capacitance value.

Steps S31 to S33 are repeated. When the measured capacitance value obtained in step S32 is approximated to the target capacitance value, step S3 is terminated.

In case of the DDS, the liquid crystal responds considerably abruptly, and therefore it is inherently difficult to form halftone display. Therefore, about three to seven halftones may be displayed. When the third step is repeated for each of the halftones to determine the duty ratio of the Selection pulse for all the halftones for display, the process proceeds to step S4.

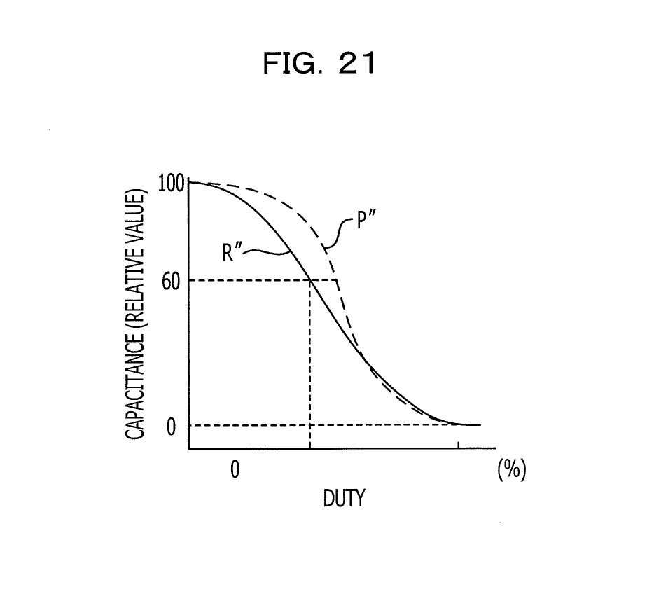

FIG. 21 illustrates the adjustment performed in the third step S3, illustrating variations in capacitance with respect to the duty ratio of the Selection pulse. In FIG. 21, R″ indicates standard characteristics of variation in capacitance with respect to the duty ratio, and P″ indicates the characteristics of variation in capacitance with respect to the duty ratio to be adjusted. This example corresponds to a case where the Evolution voltage is determined with the set halftone being 25% in the second step S2. In this case, a desired capacitance value, that is, desired halftone, is obtained by driving in accordance with the DDS with the duty ratio of the Selection pulse set to 25% and using the Evolution voltage determined in step S2. In FIG. 21, however, the characteristics of the display element to be adjusted have a steep gradient compared to the assumed characteristics R″, and therefore the assumed capacitance value (halftone) may not be obtained by driving with the assumed duty ratio of the Selection pulse. For example, with the assumed characteristics R″, the capacitance value (halftone) at the 60% point is obtained by setting the duty ratio to 40%. With the characteristics P″ of the display element to be adjusted, however, it is necessary to set the duty ratio to 50%.

For a capacitance at the halftone portion, a duty ratio of the Selection pulse at which such a capacitance (halftone) is obtained is determined, and the driving conditions are updated using the thus determined duty ratio of the Selection pulse. The duty ratio of the Selection pulse is determined by applying Newton's method or the bisection method to each capacitance at the halftone portion. In case of the DDS, the liquid crystal responds considerably abruptly, and therefore it is inherently difficult to form a halftone display. Therefore, while Newton's method may be used to determine the duty ratio of the Selection pulse, the bisection method is better in finding an optimum value because of the lower risk of resulting in a divergence.

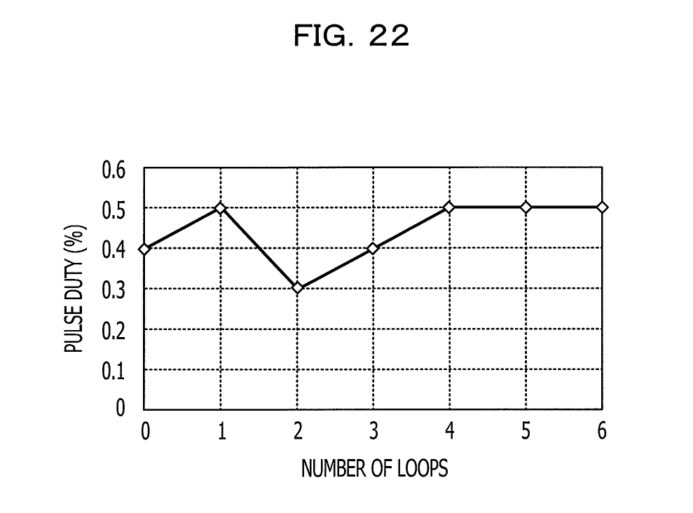

FIG. 22 illustrates variations in duty ratio that occur in the case where the bisection method is performed to determine the duty ratio at which the capacitance at the 60% point is obtained. It is found that a convergence to a substantially constant value is achieved by repeating the processes five times or more.

According to the display device of the first embodiment configured described above, it is possible to automatically optimize the driving conditions so as to constantly perform good display even in the case where the characteristics of the display element 10 fluctuate because of lot-to-lot variability and variations over time.

In the display device according to the first embodiment, in detecting the capacitance of the display element 10, the display element 10 is driven in accordance with the DDS such that all the pixels are brought into the same display state. In driving the display element 10 in accordance with the DDS, it is necessary to apply a driving waveform such as that illustrated in FIG. 8 to all the scan lines while shifting the application position, which requires considerable time. Therefore, it is desirable to perform step S31 of FIG. 16 for all the halftones for display. Thus, in case of eight-tone display, it is necessary to set the display state about five times for each of seven halftones, which requires a long time to set the display screen.

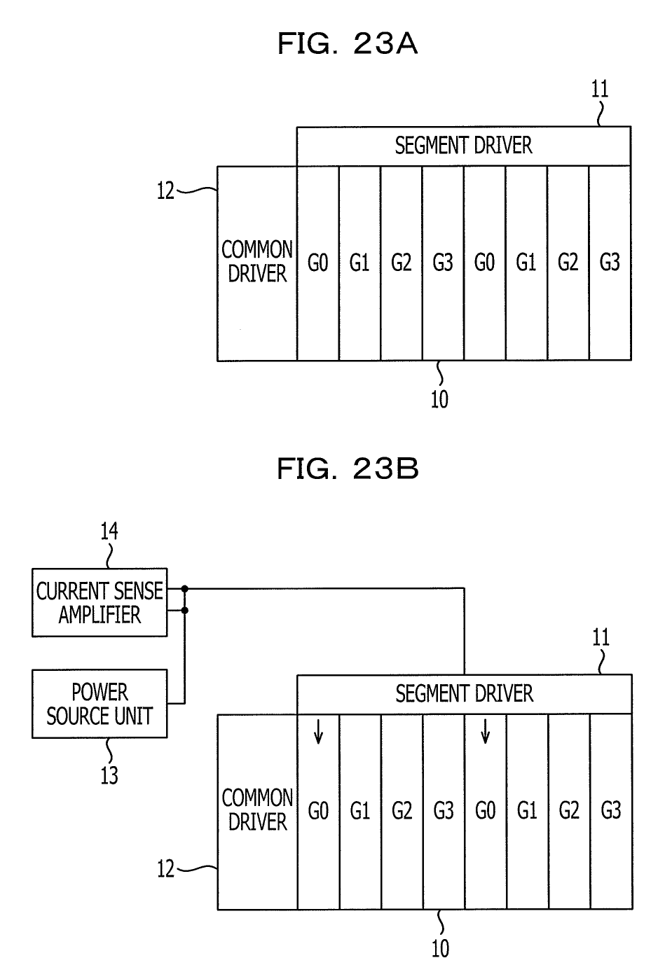

Thus, as illustrated in FIG. 23A, the display screen of the display element 10 is divided into a plurality of regions (in FIG. 23A, eight regions) corresponding to the terminals of the segment driver 11, and the regions of the display screen perform display in different tone levels at the same time. In FIG. 23A, every two regions perform display in the same tone so that four tones, namely G0 to G3, are displayed. Then, as illustrated in FIG. 23B, the segment driver 11 is controlled so as to apply a capacitance detection signal to the regions performing display in the tone G0 when the capacitance in a state in which the tone G0 is displayed is to be measured. Thereafter, the capacitance is measured in the same manner for the tones G1 to G3. This makes it possible to shorten the time required to change the display state of the display element 10 to about a quarter that according to the first embodiment.

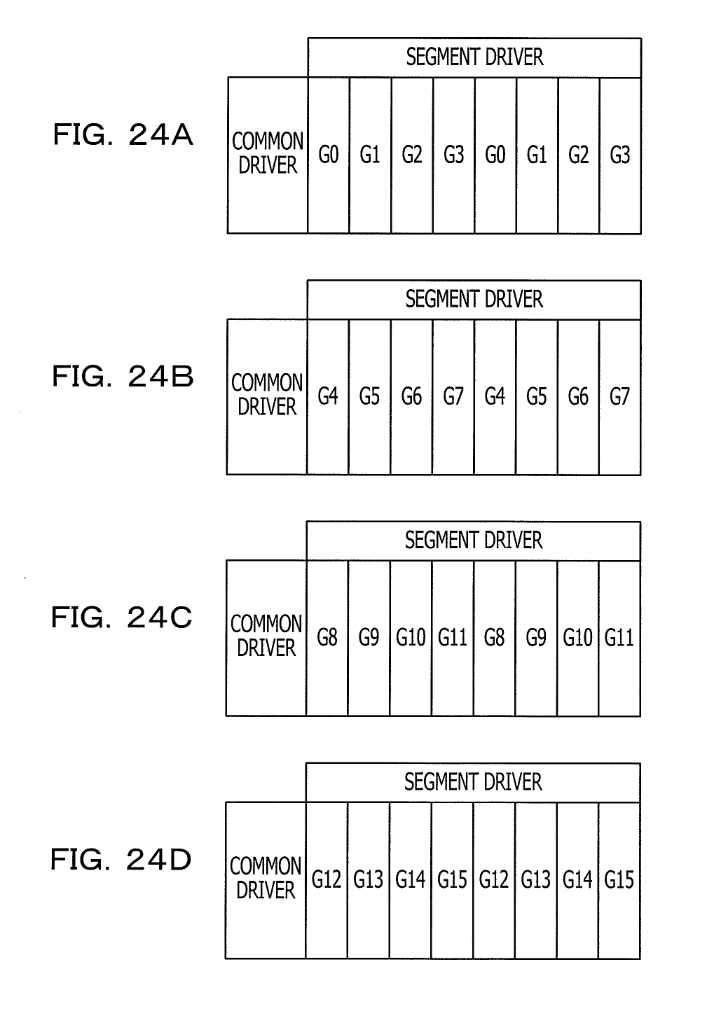

FIGS. 24A to 24D illustrate examples of the display screen for a case where the capacitance is to be measured for 16 tones, namely G0 to G15. For a first time, the third step S3 of FIG. 16 are repeated five times with four tones, namely G0 to G3, displayed. For a second time, the third step S3 of FIG. 16 are repeated five times with four tones, namely G4 to G7, displayed. Thereafter, the same operation is performed for G8 to G11 and G12 to G15.

In FIGS. 23A and 23B and FIGS. 24A to 24D, the same tone is displayed in two regions within the screen in order to eliminate the influence of screen non-uniformity.

In the display element according to the first embodiment, in the first step S1, the respective capacitances corresponding to the brightnesses of 0 and 100 (relative values) are determined. In the second step S2, the Evolution voltage is set such that a predetermined capacitance value at a predetermined halftone portion may be obtained from the capacitances determined in the first step S1. In the third step S3, the relationship between the capacitance value at the halftone portion and the duty ratio of the Selection pulse is set using the Evolution voltage determined in the second step S2. In the case where fluctuations between the brightnesses of 0 and 100 (relative values) and the corresponding capacitances are small because of the characteristics of the display element, the first step S1 may be omitted. Also in this case, it is necessary to perform steps S2 and S3 in the case where the characteristics of variation in capacitance with respect to the Evolution voltage of FIG. 14 fluctuate to be shifted in the horizontal direction. In the case where the characteristics of variation in capacitance with respect to the Evolution voltage of FIG. 14 fluctuate to be shifted in the horizontal direction to a lesser degree, step S2 may be further omitted to perform step S3.

Conversely, in the case where variations in capacitance value (halftone) with respect to the duty ratio of the Selection pulse illustrated in FIG. 21 fluctuate to a lesser degree, the third step S3 may be omitted.

In the display device according to the first embodiment, the Evolution voltage and the duty ratio of the Selection pulse are adjusted so as to obtain desired display characteristics. However, there are also other factors of the driving conditions that may vary the display characteristics as discussed earlier. In the case where such factors are to be adjusted, the technique described above in which the capacitance of the display element is detected in different display states and the driving conditions are adjusted on the basis of the detected capacitance may also be applied.

In the display device according to the first embodiment, further, a unipolar driver IC is used. However, a bipolar driver IC may also be used.

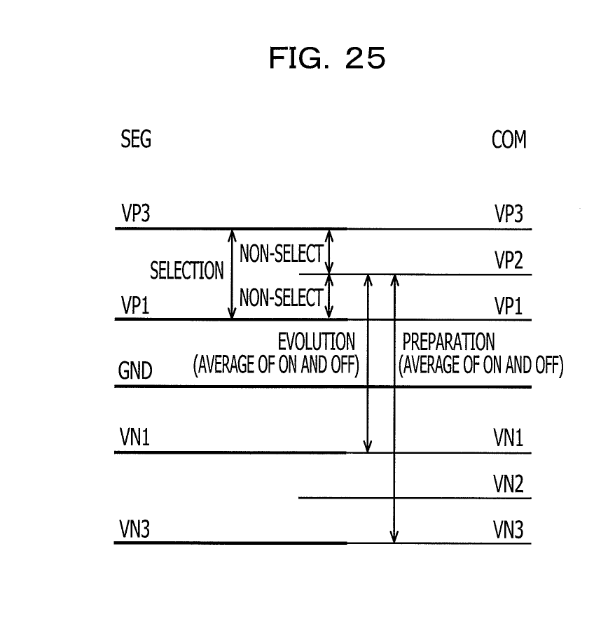

FIG. 25 illustrates the correlation between output voltages of the segment driver 11 and the common driver 12 in the case where the bipolar driver IC is used.

Voltages are defined as VP3, VP2, VP1, 0, VN1, VN2, and VN3 in descending order of voltage from the positive side to the negative side. During a positive phase, a voltage difference between SEG-VP3 and COM-VP1 is applied in the Selection period for rendering of white display, and a voltage difference between SEG-VP1 and COM-VP1 is applied in the Selection period for rendering of black display. In the Preparation period and the Evolution period, an average voltage is applied in accordance with the relationship of FIGS. 20A to 20C. During a negative phase, the correlation between VP and VN is reversed from that described above.

Formulas for deriving VP3, VP2, VP1, 0, VN1, VN2, and VN3 for each of SEG and COM from the Evolution voltage will be provided below. A Non-Select voltage is a voltage applied to all the pixels, rendered or unrendered, in none of the Preparation period, the Selection period, and the Evolution period.

SEG_{—}VP3=((Evolution voltage)+3*Non-Select voltage)/2

SEG_{—}VP2=(((Evolution voltage)+3*Non-Select voltage)−Non-Select voltage)−SEG_{—}VP3

SEG_{—}VP1=SEG_{—}VP3−Non-Select voltage*2

SEG_{—}VN3=−(SEGVP3)

SEG_{—}VN2=−(SEG_{—}VP2)

SEG_{—}VN1=−(SEG_{—}VP1)

COM_{—}VP3=SEG_{—}VP3

COM_{—}VP2=SEG_{—}VP2

COM_{—}VP1=SEG_{—}VP1

COM_{—}VN3=−(COM_{—}VP3)

COM_{—}VN2=−(COM_{—}VP2)

COM_{—}VN1=−(COM_{—}VP1)

In the display device according to the first embodiment, the DDS is used. In the case where the conventional driving scheme discussed earlier is used, however, the technique described above in which the capacitance of the display element is detected in different display states and the driving conditions are adjusted on the basis of the detected capacitance may also be applied. A display device according to a second embodiment that uses the conventional driving scheme will be described below.

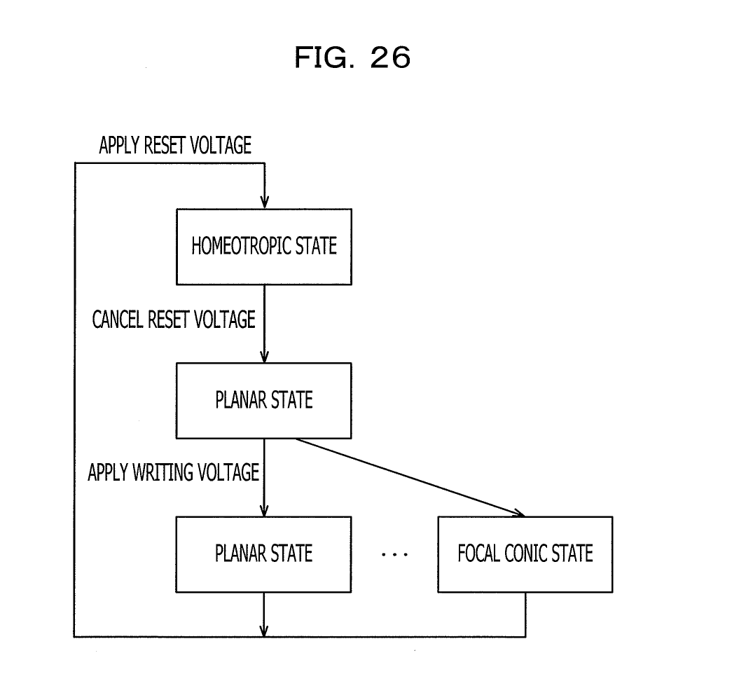

FIG. 26 illustrates variations in display state in the display device according to the second embodiment.

The cholesteric liquid crystal is brought into a homeotropic state, in which all the liquid crystal molecules are oriented in accordance with the direction of an electric field, when a strong electric field (reset voltage) is applied. The cholesteric liquid crystal is brought from the homeotropic state into the planar state when the application of the electric field is abruptly canceled. When an intermediate electric field (writing voltage) is applied, the cholesteric liquid crystal is brought from the planar state into the focal conic state. The proportion of liquid crystal molecules that are brought into the focal conic state differs in accordance with the application time. Specifically, a short application time results in a small proportion of liquid crystal molecules brought into the focal conic state, and a long application time results in a large proportion of liquid crystal molecules brought into the focal conic state.

The conventional driving scheme enables halftone display with high uniformity, which is difficult to achieve with the DDS, and is advantageous in a generally full-color display.

The display device according to the second embodiment has the same configuration as that illustrated in FIG. 1, and uses the segment driver 11 and the common driver 12 for the simple matrix scheme. The display device according to the second embodiment is different from that according to the first embodiment in adopting the conventional driving scheme. Display devices that use a cholesteric liquid crystal driven in accordance with the conventional driving scheme are well known in the art. Thus, while a detailed description will be omitted, relevant matters will be described briefly below.

The conventional driving scheme includes a reset process in which all the pixels to be rewritten are brought into the homeotropic state by applying a reset voltage, and thereafter brought into the planar state by canceling the application of the reset voltage, and a writing process in which a writing pulse is applied to each of the pixels to display an image by adjusting the application time of the writing pulse.

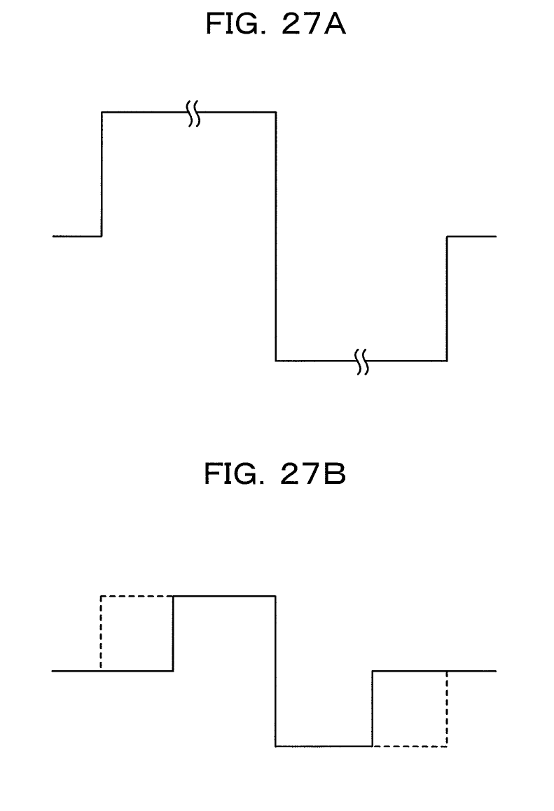

FIG. 27A illustrates a reset pulse applied to all the pixels during the reset process, which is a pulse at ±36 V with a width of several tens of ms, for example.

As described above, the ratio of the coexisting focal conic state varies in accordance with the application time of the writing voltage. There are roughly two methods of varying the application time of the writing voltage. A first method is to vary the application time by varying the width of a pulse. A second method is to vary the application time by varying the number of consecutive short pulses.

FIG. 27B illustrates a writing pulse for a case where the first method is executed. The writing pulse is a pulse at ±20 V with a different pulse width. Specifically, the common driver 12 applies a scan pulse to each scan line while shifting the position of the scan line for application of the scan pulse one by one. The period of the scan pulse applied to each line corresponds to the maximum pulse width of the writing pulse. The segment driver 12 outputs a signal for turning on and off the writing pulse in synchronization with the application of the scan pulse. This allows writing for all the pixels in one scan line to which the scan pulse is applied. No writing pulse is applied to pixels that are maintained in the planar state (white display). A writing pulse with a width corresponding to the period of the scan pulse is applied to pixels that are brought into the focal conic state (black display). A writing pulse with a width corresponding to a tone is applied to pixels for halftone display.

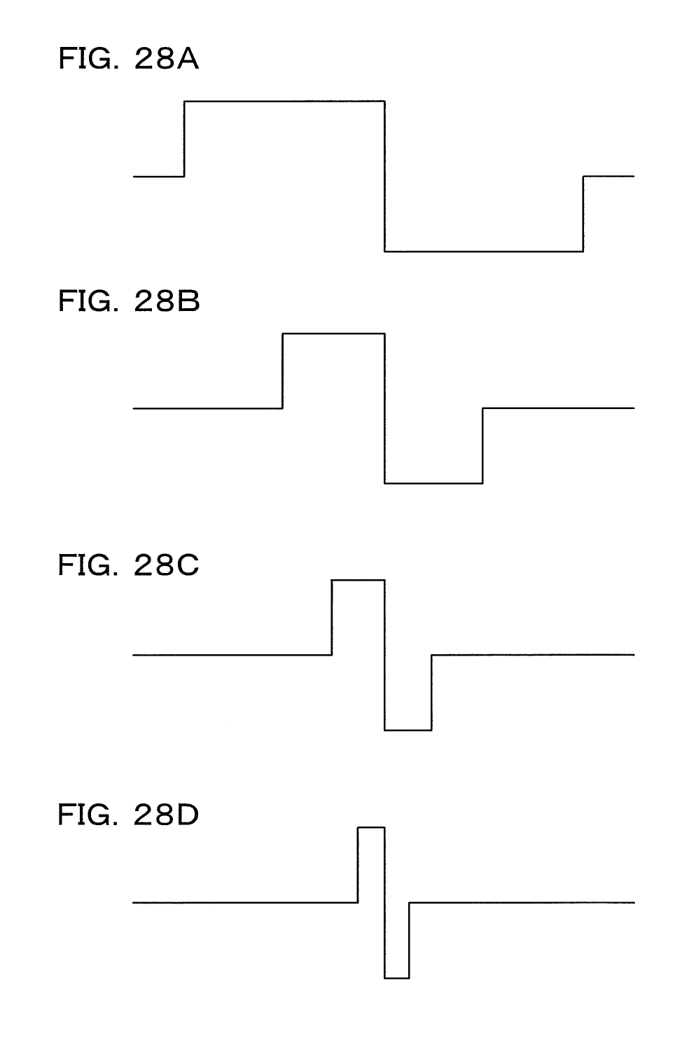

FIGS. 28A to 28D illustrate writing pulses for a case where the second method is executed. The pulses of FIGS. 28A to 28D are respectively applied to four frames. The respective widths of the writing pulses of FIGS. 28A to 28D are sequentially reduced to half. In a first frame, the common driver 12 applies a scan pulse corresponding to the scan pulse of FIG. 27A to each scan line while shifting the position of the scan line for application of the scan pulse one by one. The segment driver 12 outputs a signal for turning on and off the writing pulse in synchronization with the application of the scan pulse. Thereafter, the writing pulses of FIGS. 28B to 28D are applied in the same manner. A writing pulse with a width of 8 is applied to pixels for which no pulse other than the writing pulse of FIG. 28A is turned on, a writing pulse with a width of 4 is applied to pixels for which no pulse other than the writing pulse of FIG. 28B is turned on, and so forth. Thus, a writing pulse with a width of 15 is applied to pixels for which all the writing pulses of FIGS. 28A to 28D are turned on, and no writing pulse is applied to pixels for which all the writing pulse of FIGS. 28A to 28D are turned off.

In the display device according to the second embodiment, examples of adjustable parameters of the driving conditions include the voltage of the writing pulse in the writing process, the maximum accumulated time of the writing pulses, and the pulse width. These parameters are optimized by applying Newton's method, the bisection method, or the like while measuring the capacitance of the display element set to a display state.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A display device comprising:
a display element that maintains its display state even when no longer driven;
a capacitance detecting circuit that detects a capacitance of the display element; and
a driving condition adjusting circuit that drives the display element under predetermined driving conditions to set the display element to the display state, and that adjusts the driving conditions as a function of the capacitance of the display element exhibiting the display state detected by the capacitance detecting circuit.

2. The display device according to claim 1,
wherein the driving condition adjusting circuit adjusts the driving conditions as a function of the capacitance detected with the display element in at least two or more different display states.

3. The display device according to claim 1,
wherein the capacitance detecting circuit includes:
a current detection waveform application circuit that generates a signal having a current detection waveform to apply the signal to the display element; and
a current detecting circuit that detects a value of a current to the display element when the signal is applied.

4. The display device according to claim 3,
wherein the current detection waveform is a saw-tooth wave or a triangular wave.

5. The display device according to claim 3,
wherein the current detecting circuit measures a current to be supplied to a segment driver that drives the display element in accordance with a simple matrix scheme.

6. The display device according to claim 1,
wherein the capacitance detecting circuit detects the capacitance by setting an entire surface of the display element to a predetermined display state, and then applying a signal having a current detection waveform to the display element.

7. The display device according to claim 5,
wherein the capacitance detecting circuit detects the capacitance by dividing a display surface of the display element into regions corresponding to output terminals of the segment driver, setting each of the regions of the display surface of the display element to a predetermined display state, and then applying the signal having the current detection waveform to each of the regions.

8. The display device according to claim 3,
wherein the driving condition adjusting circuit includes:
an A/D converter that converts a current value detected by the current detecting circuit into a digital value; and
a computation circuit that computes the driving conditions as a function of the digital value output from the A/D converter.

9. The display device according to claim 1,
wherein the driving condition adjusting circuit adjusts variable parameters of the driving conditions such that the capacitance detected by the capacitance detecting circuit when the display element exhibits a predetermined display state is approximated to a target capacitance.

10. The display device according to claim 9,
wherein the driving condition adjusting circuit adjusts the variable parameters such that the detected capacitance is approximated to the target capacitance by applying Newton's method or a bisection method.

11. The display device according to claim 1,
wherein the display element is a display element that uses a cholesteric liquid crystal.

12. The display device according to claim 1,
wherein the display element includes a stacked structure formed by a plurality of liquid crystal layers that reflect different light, and
the driving condition adjusting circuit adjusts the driving conditions for each of the layers.

13. The display device according to claim 1,
wherein the display element is driven in accordance with a dynamic driving scheme.

14. The display device according to claim 13,
wherein the driving condition adjusting circuit adjusts the driving conditions using a voltage value for an Evolution period and a duty ratio for a Selection period as parameters.

15. A method of controlling driving of a display device having a display element that maintains its display state even when no longer driven, comprising:
driving the display element under predetermined driving conditions to set the display element to a display state, and then detecting a capacitance of the display element in the set display state; and
automatically adjusting the driving conditions as a function of the detected capacitance.

16. The method of controlling driving of a display device according to claim 15,
wherein the capacitance is detected with the display element in at least two or more different display states, and
the driving conditions are adjusted as a function of the capacitance detected with the display element in at least two or more different display states.

17. The method of controlling driving of a display device according to claim 15,
wherein the capacitance is detected by:
generating a signal having a current detection waveform to apply the signal to the display element;
detecting a value of a current to the display element when the signal having the current detection waveform is applied; and
calculating the capacitance from the detected current value.

18. The method of controlling driving of a display device according to claim 15,
wherein the driving conditions are adjusted by adjusting variable parameters of the driving conditions such that the capacitance detected when the display element exhibits a predetermined display state is approximated to a target capacitance.
